(19) United States
(12) Patent Application Publication
(10) Pub. No.: US 2026/0214535 A1
(43) Pub. Date: Jul. 23, 2026

(54) METHOD FOR SELECTING OR RESELECTING RELAY USER EQUIPMENT AND COMMUNICATION DEVICE

(71) Applicant: Beijing Xiaomi Mobile Software Co., Ltd., Beijing (CN)

(72) Inventor: Xiaowei JIANG, Beijing (CN)

(73) Assignee: Beijing Xiaomi Mobile Software Co., Ltd., Beijing (CN)

(21) Appl. No.: 19/143,020

(22) PCT Filed: Dec. 29, 2022
(86) PCT No.: PCT/CN2022/143671

§ 371 Date: Jun. 25, 2025

(51) Int. Cl. H04W 36/00; H04B 17/318; H04W 8/00; H04W 36/30; H04W 92/18

(52) U.S. Cl. CPC H04W 36/03; H04B 17/328; H04W 8/005; H04W 36/302; H04W 36/305; H04W 92/18

(57) ABSTRACT

A method for selecting or reselecting relay user equipment is provided. The method for selecting or reselecting relay user equipment is performed by a first user equipment and includes: triggering selecting or reselecting the relay user equipment in a case where a condition for triggering selecting or reselecting the relay user equipment is satisfied.

### CROSS-REFERENCE TO RELATED APPLICATION

The present application is a U.S. National Stage of International Application No. PCT/CN2022/143671, filed on Dec. 29, 2022, the contents of all of which are incorporated herein by reference in their entirety for all purposes.

### BACKGROUND OF THE INVENTION

In the related art, for supporting direct communication between user equipment (UE) and user equipment (UE), a sidelink communication mode is introduced. UE A may be indirectly connected to UE B. The UE A may connect to the UE B through relay UE C. The UE A and the UE B may be referred to as remote UEs, the UE C that provides a relaying function may be referred to as a relay UE. All UEs communicate with each other via sidelink unicast, and this type of architecture is called UE to UE (U2U) relaying.

### SUMMARY OF THE INVENTION

The present disclosure relates to the technical field of communication, in particular to a method for selecting or reselecting a relay user equipment, and a communication device.

According to an embodiment of a first aspect of the present disclosure, a method for selecting or reselecting a relay user equipment is provided. The method includes:
triggering selecting or reselecting the relay user equipment in a case where a condition for triggering selecting or reselecting the relay user equipment is satisfied.

According to an embodiment of a second aspect of the present disclosure, a method for selecting or reselecting a relay user equipment is provided. The method includes:
obtaining a first sidelink reference signal receiving power (SL-RSRP) or a first sidelink discovery reference signal receiving power (SD-RSRP) of a link between a first user equipment and a second user equipment; and
transmitting first indication signaling to the first user equipment in a case where the first SL-RSRP or the first SD-RSRP is less than or equal to a first preset threshold, where the first indication signaling indicates that the first SL-RSRP or the first SD-RSRP is less than or equal to the first preset threshold.

According to an embodiment of a third aspect of the present disclosure, a method for selecting or reselecting a relay user equipment is provided. The method includes:
obtaining a third SL-RSRP or a third SD-RSRP of a link between a second user equipment and the relay user equipment; and
transmitting third indication signaling to a first user equipment in a case where the third SL-RSRP or the third SD-RSRP is less than or equal to a third preset threshold, where the third indication signaling indicates that the third SL-RSRP or the third SD-RSRP is less than or equal to the third preset threshold.

According to an embodiment of a fourth aspect of the present disclosure, a communication device is provided, including:
a processing module, configured to trigger selecting or reselecting a relay user equipment in a case where a condition for triggering selecting or reselecting the relay user equipment is satisfied.

According to an embodiment of a fifth aspect of the present disclosure, another communication device is provided, including:
a processing module, configured to obtain a first SL-RSRP or a first SD-RSRP of a link between a first user equipment and a second user equipment; and
a transceiving module, configured to transmit first indication signaling to the first user equipment in a case where the first SL-RSRP or the first SD-RSRP is less than or equal to a first preset threshold, where the first indication signaling indicates that the first SL-RSRP or the first SD-RSRP is less than or equal to the first preset threshold.

According to an embodiment of a sixth aspect of the present disclosure, another communication device is provided, including:
a processing module, configured to obtain a third SL-RSRP or a third SD-RSRP of a link between a second user equipment and a relay user equipment; and
a transceiving module, configured to transmit third indication signaling to a first user equipment in a case where the third SL-RSRP or the third SD-RSRP is less than or equal to a third preset threshold, where the third indication signaling indicates that the third SL-RSRP or the third SD-RSRP is less than or equal to the third preset threshold.

According to an embodiment of a seventh aspect of the present disclosure, a communication device is provided, including one or more processors, where the one or more processors, when collectively calling a computer program in a memory, cause the communication device to perform the method in the first aspect.

According to an embodiment of an eighth aspect of the present disclosure, a communication device is provided, including one or more processors, where the one or more processors, when collectively calling a computer program in a memory, cause the communication device to perform the method in the second aspect.

According to an embodiment of a ninth aspect of the present disclosure, a communication device is provided, including one or more processors, where the one or more processors, when collectively calling a computer program in a memory, cause the communication device to perform the method in the third aspect.

According to an embodiment of a tenth aspect of the present disclosure, a communication device is provided, including one or more processors and a memory, where the memory stores a computer program; and the one or more processors, when collectively executing the computer program stored in the memory, cause the communication device to perform the method in the first aspect.

According to an embodiment of an eleventh aspect of the present disclosure, a communication device is provided, including one or more processors and a memory, where the memory stores a computer program; and the one or more processors, when collectively executing the computer program stored in the memory, cause the communication device to perform the method in the second aspect.

According to an embodiment of a twelfth aspect of the present disclosure, a communication device is provided, including one or more processors and a memory, where the memory stores a computer program; and the one or more processors, when collectively executing the computer program stored in the memory, cause the communication device to perform the method in the third aspect.

According to an embodiment of a thirteenth aspect of the present disclosure, another communication device is provided, including one or more processors and an interface circuit, where the interface circuit is configured to receive a code instruction and transmit the code instruction to the one or more processors, and the one or more processors are collectively configured to run the code instruction to cause the communication device to perform the method in the first aspect.

According to an embodiment of a fourteenth aspect of the present disclosure, another communication device is provided, including one or more processors and an interface circuit, where the interface circuit is configured to receive a code instruction and transmit the code instruction to the one or more processors, and the one or more processors are collectively configured to run the code instruction to cause the communication device to perform the method in the second aspect.

According to an embodiment of a fifteenth aspect of the present disclosure, another communication device is provided, including one or more processors and an interface circuit, where the interface circuit is configured to receive a code instruction and transmit the code instruction to the one or more processors, and the one or more processors are collectively configured to run the code instruction to cause the communication device to perform the method in the third aspect.

According to an embodiment of a sixteenth aspect of the present disclosure, a non-transitory computer-readable storage medium is provided, configured to store instructions used for the communication device, where the instructions, when executed by one or more processors of the communication device, cause the communication device to perform the method in the first aspect.

According to an embodiment of a seventeenth aspect of the present disclosure, a non-transitory computer-readable storage medium is provided, configured to store instructions used for the communication device, where the instructions, when executed by one or more processors of the communication device, cause the communication device to perform the method in the second aspect.

According to an embodiment of an eighteenth aspect of the present disclosure, a non-transitory computer-readable storage medium is provided, configured to store instructions used for the communication device, where the instructions, when executed by one or more processors of the communication device, cause the communication device to perform the method in the third aspect.

According to an embodiment of a nineteenth aspect of the present disclosure, a computer program product including a computer program is further provided, where the computer program, when running on a computer, causes the computer to perform the method in the first aspect.

According to an embodiment of a twentieth aspect of the present disclosure, a computer program product including a computer program is further provided, where the computer program, when running on a computer, causes the computer to perform the method in the second aspect.

According to an embodiment of a twenty-first aspect of the present disclosure, a computer program product including a computer program is further provided, where the computer program, when running on a computer, causes the computer to perform the method in the third aspect.

According to an embodiment of a twenty-second aspect of the present disclosure, a chip system is provided, including at least one processor and an interface, configured to support a communication device to implement functions involved in the first aspect.

According to an embodiment of a twenty-third aspect of the present disclosure, a chip system is provided, including at least one processor and an interface, configured to support a communication device to implement functions involved in the second aspect.

According to an embodiment of a twenty-fourth aspect of the present disclosure, a chip system is provided, including at least one processor and an interface, configured to support a communication device to implement functions involved in the third aspect.

According to an embodiment of a twenty-fifth aspect of the present disclosure, a computer program is further provided, where the computer program, when running on a computer, causes the computer to perform the method in the first aspect.

According to an embodiment of a twenty-sixth aspect of the present disclosure, a computer program is further provided, where the computer program, when running on a computer, causes the computer to perform the method in the second aspect.

According to an embodiment of a twenty-seventh aspect of the present disclosure, a computer program is further provided, where the computer program, when running on a computer, causes the computer to perform the method in the third aspect.

### BRIEF DESCRIPTION OF DRAWINGS

In order to describe technical solutions in the embodiments of the present disclosure or the background more clearly, accompanying drawings needed by the embodiments of the present disclosure or the background will be described below.

FIG. 1 is a schematic architectural diagram of a communication system provided by an embodiment of the present disclosure.

FIG. 2 is a schematic flowchart of a method for selecting or reselecting a relay user equipment provided by an embodiment of the present disclosure.

FIG. 3 is a schematic flowchart of a method for selecting or reselecting a relay user equipment provided by another embodiment of the present disclosure.

FIG. 4 is a schematic flowchart of a method for selecting or reselecting a relay user equipment provided by another embodiment of the present disclosure.

FIG. 5 is a schematic flowchart of a method for selecting or reselecting a relay user equipment provided by another embodiment of the present disclosure.

FIG. 6 is a schematic flowchart of a method for selecting or reselecting a relay user equipment provided by another embodiment of the present disclosure.

FIG. 7 is a schematic flowchart of a method for selecting or reselecting a relay user equipment provided by another embodiment of the present disclosure.

FIG. 8 is a schematic flowchart of a method for selecting or reselecting a relay user equipment provided by another embodiment of the present disclosure.

FIG. 9 is a schematic flowchart of a method for selecting or reselecting a relay user equipment provided by another embodiment of the present disclosure.

FIG. 10 is a schematic flowchart of a method for selecting or reselecting a relay user equipment provided by another embodiment of the present disclosure.

FIG. 11 is a schematic flowchart of a method for selecting or reselecting a relay user equipment provided by another embodiment of the present disclosure.

FIG. 12 is a schematic flowchart of a method for selecting or reselecting a relay user equipment provided by another embodiment of the present disclosure.

FIG. 13 is a schematic flowchart of a method for selecting or reselecting a relay user equipment provided by another embodiment of the present disclosure.

FIG. 14 is a schematic flowchart of a method for selecting or reselecting a relay user equipment provided by another embodiment of the present disclosure.

FIG. 15 is a schematic flowchart of a method for selecting or reselecting a relay user equipment provided by another embodiment of the present disclosure.

FIG. 16 is a schematic flowchart of a method for selecting or reselecting a relay user equipment provided by another embodiment of the present disclosure.

FIG. 17 is a schematic flowchart of a method for selecting or reselecting a relay user equipment provided by another embodiment of the present disclosure.

FIG. 18 is a schematic flowchart of a method for selecting or reselecting a relay user equipment provided by another embodiment of the present disclosure.

FIG. 19 is a schematic flowchart of a method for selecting or reselecting a relay user equipment provided by another embodiment of the present disclosure.

FIG. 20 is a schematic flowchart of a method for selecting or reselecting a relay user equipment provided by another embodiment of the present disclosure.

FIG. 21 is a schematic structural diagram of a communication device provided by an embodiment of the present disclosure.

FIG. 22 is a schematic structural diagram of a communication device provided by another embodiment of the present disclosure.

FIG. 23 is a schematic structural diagram of a chip provided by an embodiment of the present disclosure.

### DETAILED DESCRIPTION OF THE INVENTION

In order to better understand a method for selecting or reselecting a relay user equipment provided by an embodiment of the present disclosure, a communication system suitable for embodiments of the present disclosure is described below firstly.

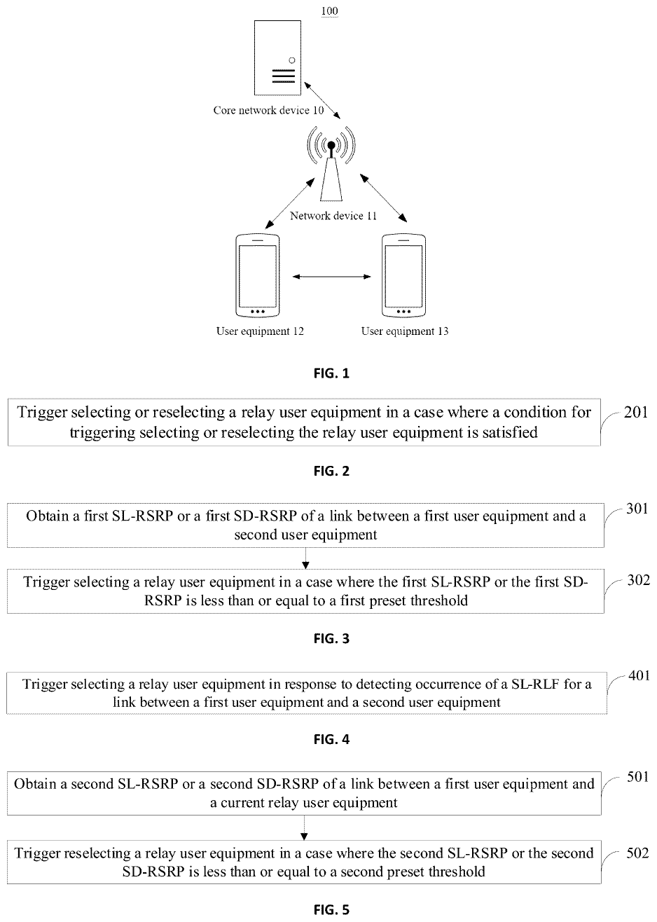

Please refer to FIG. 1, FIG. 1 is a schematic architectural diagram of a communication system 100 provided by an embodiment of the present disclosure. The communication system 100 may include but is not limited to one network device and two user equipment. The two user equipment are connected through a sidelink (SL). The number and form of devices shown in FIG. 1 are merely examples and do not constitute a limitation on the embodiments of the present disclosure. In actual application, two or more network devices and two or more user equipment may be included. For example, the communication system 100 shown in FIG. 1 includes one network device 11 and two user equipment 12 and 13, where the user equipment 12 and the user equipment 13 are connected through SL. The communication system 100 may further include a core network device 10 to communicate with the network device 11.

In the present disclosure, the user equipment 12 may be a transmitting terminal, and the user equipment 13 may be a peer terminal. There may be one or more user equipment 13, which is not limited in the present disclosure. Alternatively, the user equipment 13 may be a transmitting terminal, and the user equipment 12 may be a peer terminal. There may be one or more user equipment 12, which is not limited in the present disclosure.

It needs to be noted that the technical solutions of the embodiments of the present disclosure may be applied to various communication systems. For example, there are a long term evolution (LTE) system, a 5th generation (5G) mobile communication system, a 5G new radio (NR) system, other future new mobile communication systems, or the like.

The network device 11 in the embodiment of the present disclosure is an entity on a network side for transmitting or receiving a signal. For example, the network device 11 may be an evolved NodeB (eNB), a transmission reception point (TRP), a next generation NodeB (gNB) in an NR system, a base station in another future mobile communication system, an access node in a wireless fidelity (WiFi) system, or the like.

The embodiment of the present disclosure does not limit a technology and a device form adopted by the network device. The network device provided by the embodiment of the present disclosure may be composed of a central unit (CU) and a distributed unit (DU). The CU may also be called control unit. A CU-DU structure may split protocol layers of the network device such as a base station, functions of some protocol layers are under centralized control in the CU, and functions of some or all of the rest of protocol layers are distributed in the DU which is under centralized control by the CU.

The user equipment in the embodiment of the present disclosure is an entity, for example, a mobile phone, on a user side for receiving or transmitting a signal. The user equipment may also be called a terminal, a mobile station (MS), a mobile terminal (MT), or the like. The user equipment may be an automobile, a smart car, a mobile phone, a wearable device and a pad which have a communication function, a computer with a wireless transceiving function, a virtual reality (VR) terminal, an augmented reality (AR) terminal, a wireless terminal in industrial control, a wireless terminal in self-driving, a wireless terminal in a remote medical surgery, a wireless terminal in a smart grid, a wireless terminal in transportation safety, a wireless terminal in a smart city, a wireless terminal in a smart home, or the like. The embodiment of the present disclosure does not limit a specific technology and a specific device form adopted by the user equipment.

It may be understood that the communication system described in the embodiment of the present disclosure is intended to describe the technical solution of the embodiment of the present disclosure more clearly but does not constitute a limitation on the technical solution provided by the embodiment of the present disclosure, and those ordinarily skilled in the art may know that with evolution of a system architecture and emergence of a new service scenario, the technical solution provided by the embodiment of the present disclosure is also applicable to similar technical problems.

In a U2U scenario, there may be a case of selecting or reselecting a relay user equipment. In the present disclosure, a first user equipment may select or reselect the relay user equipment in a case where a condition for triggering selecting or reselecting the relay user equipment is satisfied, so that the first user equipment may select or reselect the relay user equipment in a case where the condition for triggering selecting or reselecting the relay user equipment is satisfied. In this way, device resources may be saved by avoiding repeatedly triggering selecting or reselecting the relay user equipment.

A method for selecting or reselecting a relay user equipment and a communication device provided by the present disclosure are introduced in detail with reference to the accompanying drawings.

Please refer to FIG. 2, FIG. 2 is a schematic flowchart of a method for selecting or reselecting a relay user equipment provided by an embodiment of the present disclosure. The method is performed by the first user equipment. As shown in FIG. 2, the method may include but is not limited to step 201.

Step 201, selecting or reselecting the relay user equipment is triggered in a case where a condition for triggering selecting or reselecting the relay user equipment is satisfied.

In the present disclosure, the first user equipment may be a user equipment for transmitting a direct communication request (DCR) message, or the first user equipment may be a user equipment for transmitting a direct communication accept (DCA) message. In other words, the first user equipment may be a source remote user equipment, or may be a target remote user equipment. Merely one of the source remote user equipment or the target remote user equipment may perform the selection or the reselection of the relay user equipment.

In the present disclosure, the condition for triggering selecting the relay user equipment may be, for example, that a sidelink radio link failure (SL-RLF) of a link between the first user equipment and a second user equipment occurs, or that a first sidelink reference signal receiving power (SL-RSRP) or a first sidelink discovery reference signal receiving power (SD-RSRP) of a link between the first user equipment and the second user equipment is less than or equal to a first preset threshold, and the like. The first user equipment may trigger selecting the relay user equipment in a case where a condition for triggering selecting the relay user equipment is satisfied.

In the present disclosure, the first user equipment may be a user equipment for transmitting the DCR message, and the second user equipment may be a user equipment for transmitting the DCA message. Alternatively, the second user equipment may be the user equipment for transmitting the DCR message, and the first user equipment may be the user equipment for transmitting the DCA message. In other words, in a case where the first user equipment is the source remote user equipment, the second user equipment is the target remote user equipment. In a case where the second user equipment is the source remote user equipment, the first user equipment is the target remote user equipment.

In the present disclosure, the condition for triggering reselecting the relay user equipment may be, for example, that a SL-RLF for a link between the first user equipment and the relay user equipment occurs, or that a SL-RSRP or a SD-RSRP of a link between the first user equipment and the relay user equipment is less than or equal to a second preset threshold, and the like. The first user equipment may trigger reselecting the relay user equipment in a case where the condition for triggering reselecting the relay user equipment is satisfied.

It needs to be noted that the first preset threshold and the second preset threshold may be the same or not. The first preset threshold and the second preset threshold may be configured or pre-configured by a network device, which is not limited in the present disclosure.

In the embodiment of the present disclosure, the first user equipment may select or reselect the relay user equipment in a case where the condition for triggering selecting or reselecting the relay user equipment is satisfied, so that the first user equipment may select or reselect the relay user equipment in a case where the condition for triggering selecting or reselecting the relay user equipment is satisfied. In this way, device resources are saved by avoiding repeatedly triggering selecting or reselecting the relay user equipment.

Please refer to FIG. 3, FIG. 3 is a schematic flowchart of a method for selecting or reselecting a relay user equipment provided by another embodiment of the present disclosure. The method is performed by a first user equipment. As shown in FIG. 3, the method may include but is not limited to steps 301 to 302.
Step 301, a first SL-RSRP or a first SD-RSRP of a link between the first user equipment and a second user equipment is obtained.

In the present disclosure, the first user equipment may obtain the first SL-RSRP of the link between the first user equipment and the second user equipment, or may also obtain the first SD-RSRP of the link between the first user equipment and the second user equipment.

In the present disclosure, the first user equipment may be a user equipment for transmitting a DCR message, and the second user equipment may be a user equipment for transmitting a DCA message. Alternatively, the second user equipment may be the user equipment for transmitting the DCR message, and the first user equipment may be the user equipment for transmitting the DCA message. In other words, in a case where the first user equipment is a source remote user equipment, the second user equipment is a target remote user equipment. In a case where the second user equipment is the source remote user equipment, the first user equipment is the target remote user equipment.

In some examples, in a case where data transmission exists between the first user equipment and the second user equipment, the first user equipment may obtain the first SL-RSRP between the first user equipment and the second user equipment according to a signal intensity of received data transmitted by the second user equipment.

In some examples, in a case where no data transmission exists between the first user equipment and the second user equipment, the first user equipment may obtain the first SL-RSRP or the first SD-RSRP of the link between the first user equipment and the second user equipment according to a signal intensity of a received discovery request message transmitted by the second user equipment.
Step 302, selecting the relay user equipment is triggered in a case where the first SL-RSRP or the first SD-RSRP is less than or equal to a first preset threshold.

In the present disclosure, in a case where the first SL-RSRP or the first SD-RSRP is less than or equal to the first preset threshold, the first user equipment may trigger selecting the relay user equipment.

In the embodiment of the present disclosure, the first user equipment may obtain the first SL-RSRP or the first SD-RSRP of the link between the first user equipment and the second user equipment and trigger selecting the relay user equipment in a case where the first SL-RSRP or the first SD-RSRP is less than or equal to the first preset threshold. Accordingly, the first user equipment may select the relay user equipment in response to detecting that the first SL-RSRP or the first SD-RSRP of the link between the first user equipment and the second user equipment is less than or equal to the first preset threshold, so that resources of the second user equipment may be saved by preventing the first user equipment and the second user equipment from repeatedly triggering selecting the relay user equipment.

Please refer to FIG. 4, FIG. 4 is a schematic flowchart of a method for selecting or reselecting a relay user equipment provided by another embodiment of the present disclosure. The method is performed by a first user equipment. As shown in FIG. 4, the method may include but is not limited to step 401.
Step 401, selecting the relay user equipment is triggered in response to detecting occurrence of a SL-RLF for a link between the first user equipment and a second user equipment.

In the present disclosure, the first user equipment may trigger selecting the relay user equipment in a case where the occurrence of the SL-RLF for the link between the first user equipment and the second user equipment is detected.

In the present disclosure, the first user equipment may be a user equipment for transmitting a DCR message, and the second user equipment may be a user equipment for transmitting a DCA message. Alternatively, the second user equipment may also be the user equipment for transmitting the DCR message, and the first user equipment may be the user equipment for transmitting the DCA message. In other words, in a case where the first user equipment is a source remote user equipment, the second user equipment is a target remote user equipment. In a case where the second user equipment is the source remote user equipment, the first user equipment is the target remote user equipment.

In the embodiment of the present disclosure, the first user equipment triggers selecting the relay user equipment in response to detecting the occurrence of the SL-RLF for the link between the first user equipment and the second user equipment, so that the first user equipment may select the relay user equipment in response to detecting the occurrence of the SL-RLF for the link between the first user equipment and the second user equipment, and thus resources of the second user equipment may be saved by preventing the first user equipment and the second user equipment from repeatedly triggering selecting the relay user equipment.

Please refer to FIG. 5, FIG. 5 is a schematic flowchart of a method for selecting or reselecting a relay user equipment provided by another embodiment of the present disclosure. The method is performed by a first user equipment. As shown in FIG. 5, the method may include but is not limited to steps 501 to 502.
Step 501, a second SL-RSRP or a second SD-RSRP of a link between the first user equipment and a current relay user equipment is obtained.

In the present disclosure, the first user equipment may obtain the second SL-RSRP of the link between the first user equipment and the current relay user equipment, or may also obtain the second SD-RSRP of the link between the first user equipment and the current relay user equipment.

In the present disclosure, the first user equipment may be a user equipment for transmitting a DCR message, and the second user equipment may be a user equipment for transmitting a DCA message. Alternatively, the second user equipment may also be the user equipment for transmitting the DCR message, and the first user equipment may be the user equipment for transmitting the DCA message. In other words, in a case where the first user equipment is a source remote user equipment, the second user equipment is a target remote user equipment. In a case where the second user equipment is the source remote user equipment, the first user equipment is the target remote user equipment.

In some examples, in a case where data transmission exists between the first user equipment and the current relay user equipment, the first user equipment may obtain the second SL-RSRP of the link between the first user equipment and the relay user equipment according to a signal intensity of received data transmitted by the relay user equipment.

In some examples, in a case where no data transmission exists between the first user equipment and the relay user equipment, the first user equipment may obtain the second SL-RSRP or the second SD-RSRP of the link between the first user equipment and the relay user equipment according to a signal intensity of a received discovery request message transmitted by the current relay user equipment.
Step 502, reselecting the relay user equipment is triggered in a case where the second SL-RSRP or the second SD-RSRP is less than or equal to a second preset threshold.

In the present disclosure, in a case where the second SL-RSRP or the second SD-RSRP is less than or equal to the second preset threshold, the first user equipment may trigger reselecting the relay user equipment.

In the embodiment of the present disclosure, the first user equipment may obtain the second SL-RSRP or the second SD-RSRP of the link between the first user equipment and the current relay user equipment and trigger reselecting the relay user equipment in a case where the second SL-RSRP or the second SD-RSRP is less than or equal to the second preset threshold. Accordingly, the first user equipment may reselect the relay user equipment in response to detecting that the second SL-RSRP or the second SD-RSRP of the link between the first user equipment and the current relay user equipment is less than or equal to the second preset threshold, so that resources of the second user equipment may be saved by preventing the first user equipment and the second user equipment from repeatedly triggering reselecting the relay user equipment.

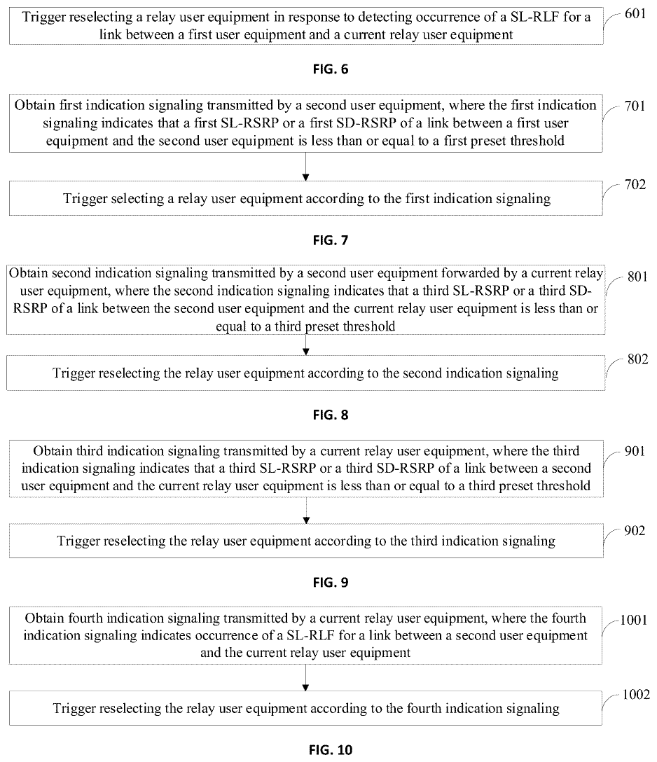

Please refer to FIG. 6, FIG. 6 is a schematic flowchart of a method for selecting or reselecting a relay user equipment provided by another embodiment of the present disclosure. The method is performed by a first user equipment. As shown in FIG. 6, the method may include but is not limited to step 601.
Step 601, reselecting the relay user equipment is triggered in response to detecting occurrence of a SL-RLF for a link between the first user equipment and a current relay user equipment.

In the present disclosure, the first user equipment may trigger reselecting the relay user equipment in response to detecting the occurrence of the SL-RLF for the link between the first user equipment and the current relay user equipment.

In the present disclosure, the first user equipment may be a user equipment for transmitting a DCR message, and the second user equipment may be a user equipment for transmitting a DCA message. Alternatively, the second user equipment may also be the user equipment for transmitting the DCR message, and the first user equipment may be the user equipment for transmitting the DCA message. In other words, in a case where the first user equipment is a source remote user equipment, the second user equipment is a target remote user equipment. In a case where the second user equipment is the source remote user equipment, the first user equipment is the target remote user equipment.

In the embodiment of the present disclosure, the first user equipment triggers reselecting the relay user equipment in a case where the occurrence of the SL-RLF for the link between the first user equipment and the current relay user equipment is detected, so that the first user equipment may reselect the relay user equipment in response to detecting that the SL-RLF for the link between the first user equipment and the relay user equipment occurs, and thus resources of the second user equipment may be saved by preventing the first user equipment and the second user equipment from repeatedly triggering reselecting the relay user equipment.

Please refer to FIG. 7, FIG. 7 is a schematic flowchart of a method for selecting or reselecting a relay user equipment provided by another embodiment of the present disclosure. The method is performed by a first user equipment. As shown in FIG. 7, the method may include but is not limited to steps 701 to 702.
Step 701, first indication signaling transmitted by a second user equipment is obtained, where the first indication signaling indicates that a first SL-RSRP or a first SD-RSRP of a link between the first user equipment and the second user equipment is less than or equal to a first preset threshold.

In the present disclosure, the first user equipment may be a user equipment for transmitting a DCR message, and the second user equipment may be a user equipment for transmitting a DCA message. Alternatively, the second user equipment may also be the user equipment for transmitting the DCR message, and the first user equipment may be the user equipment for transmitting the DCA message. In other words, in a case where the first user equipment is a source remote user equipment, the second user equipment is a target remote user equipment. In a case where the second user equipment is the source remote user equipment, the first user equipment is the target remote user equipment.

In the present disclosure, the second user equipment may obtain the first SL-RSRP or the first SD-RSRP of the link between the first user equipment and the second user equipment. In a case where the first SL-RSRP or the first SD-RSRP is less than or equal to the first preset threshold, the second user equipment may transmit first indication signaling to the first user equipment. The first indication signaling may indicate that the first SL-RSRP or the first SD-RSRP of the link between the first user equipment and the second user equipment is less than or equal to the first preset threshold, or first indication signaling may directly indicate the first user equipment to trigger selecting the relay user equipment.

In other words, the second user equipment may notify the first user equipment through the first indication signaling in response to detecting that the first SL-RSRP or the first SD-RSRP of the link between the first user equipment and the second user equipment is less than or equal to the first preset threshold.

In some examples, the first indication signaling may be PC5 radio resource control (PC5-RRC) signaling.
Step 702, selecting the relay user equipment is triggered according to the first indication signaling.

In the present disclosure, the first user equipment may know, according to the first indication signaling, that the first SL-RSRP or the first SD-RSRP of the link between the first user equipment and the second user equipment is less than or equal to the first preset threshold, and thus the first user equipment may trigger selecting the relay user equipment.

In some examples, in a case where the first indication signaling indicates the first user equipment to trigger selecting the relay user equipment, the first user equipment may trigger selecting the relay user equipment according to the first indication signaling.

In the embodiment of the present disclosure, the first user equipment may obtain the first indication signaling transmitted by the second user equipment and trigger selecting the relay user equipment according to the first indication signaling.

Accordingly, the second user equipment may notify, in response to detecting that the first SL-RSRP or the first SD-RSRP of the link between the first user equipment and the second user equipment is less than or equal to the first preset threshold, the first user equipment to trigger selecting the relay user equipment, so that resources of the second user equipment may be saved by preventing the first user equipment and the second user equipment from repeatedly selecting the relay user equipment.

Please refer to FIG. 8, FIG. 8 is a schematic flowchart of a method for selecting or reselecting a relay user equipment provided by another embodiment of the present disclosure. The method is performed by a first user equipment. As shown in FIG. 8, the method may include but is not limited to steps 801 to 802.
Step 801, second indication signaling transmitted by a second user equipment forwarded by a current relay user equipment is obtained, where the second indication signaling indicates that a third SL-RSRP or a third SD-RSRP of a link between the second user equipment and the current relay user equipment is less than or equal to a third preset threshold.

In the present disclosure, the first user equipment may be a user equipment for transmitting a DCR message, and the second user equipment may be a user equipment for transmitting a DCA message. Alternatively, the second user equipment may also be the user equipment for transmitting the DCR message, and the first user equipment may be the user equipment for transmitting the DCA message. In other words, in a case where the first user equipment is a source remote user equipment, the second user equipment is a target remote user equipment. In a case where the second user equipment is the source remote user equipment, the first user equipment is the target remote user equipment.

In the present disclosure, the second user equipment may obtain the third SL-RSRP or the third SD-RSRP of the link between the second user equipment and the current relay user equipment. In a case where the third SL-RSRP or the third SD-RSRP is less than or equal to the third preset threshold, the second indication signaling may be forwarded to the first user equipment through the relay user equipment. The second indication signaling may indicate that the third SL-RSRP or the third SD-RSRP of the link between the second user equipment and the current relay user equipment is less than or equal to the third preset threshold, or the second indication signaling may directly indicate the first user equipment to trigger reselecting the relay user equipment.

In other words, the second user equipment may forward the second indication signaling to the first user equipment through the current relay user equipment in response to detecting that the third SL-RSRP or the third SD-RSRP of the link between the second user equipment and the current relay user equipment is less than or equal to the third preset threshold.

In some examples, the second indication signaling may be PC5-RRC signaling.
Step 802, reselecting the relay user equipment is triggered according to the second indication signaling.

In the present disclosure, the first user equipment may know, according to the second indication signaling, that the third SL-RSRP or the third SD-RSRP of the link between the second user equipment and the current relay user equipment is less than or equal to the third preset threshold, and thus the first user equipment may trigger reselecting the relay user equipment.

In some examples, in a case where the second indication signaling indicate the first user equipment to trigger reselecting the relay user equipment, the first user equipment may trigger reselecting the relay user equipment according to the second indication signaling.

In the embodiment of the present disclosure, the first user equipment may obtain the second indication signaling transmitted by the second user equipment forwarded by the current relay user equipment, and trigger reselecting the relay user equipment according to the second indication signaling. Accordingly, in response to detecting that the third SL-RSRP or the third SD-RSRP of the link between the second user equipment and the current relay user equipment is less than or equal to the third preset threshold, the second user equipment may notify, through the current relay user equipment, the first user equipment to trigger reselecting the relay user equipment, so that resources of the second user equipment may be saved by preventing the first user equipment and the second user equipment from repeatedly reselecting the relay user equipment.

Please refer to FIG. 9, FIG. 9 is a schematic flowchart of a method for selecting or reselecting a relay user equipment provided by another embodiment of the present disclosure. The method is performed by a first user equipment. As shown in FIG. 9, the method may include but is not limited to steps 901 to 902.
Step 901, third indication signaling transmitted by a current relay user equipment is obtained, where the third indication signaling indicates that a third SL-RSRP or a third SD-RSRP of a link between a second user equipment and the current relay user equipment is less than or equal to a third preset threshold.

In the present disclosure, the first user equipment may be a user equipment for transmitting a DCR message, and the second user equipment may be a user equipment for transmitting a DCA message. Alternatively, the second user equipment may also be the user equipment for transmitting the DCR message, and the first user equipment may be the user equipment for transmitting the DCA message. In other words, in a case where the first user equipment is a source remote user equipment, the second user equipment is a target remote user equipment. In a case where the second user equipment is the source remote user equipment, the first user equipment is the target remote user equipment.

In the present disclosure, the current relay user equipment may obtain the third SL-RSRP or the third SD-RSRP of the link between the second user equipment and the current relay user equipment. In a case where the third SL-RSRP or the third SD-RSRP is less than or equal to the third preset threshold, the third indication signaling may be transmitted to the first user equipment. The third indication signaling may indicate that the third SL-RSRP or the third SD-RSRP of the link between the second user equipment and the current relay user equipment is less than or equal to the third preset threshold, or the third indication signaling may directly indicate the first user equipment to trigger reselecting the relay user equipment.

In other words, the current relay user equipment may notify the first user equipment through the third indication signaling in response to detecting that the third SL-RSRP or the third SD-RSRP of the link between the second user equipment and the current relay user equipment is less than or equal to the third preset threshold.

In some examples, the third indication signaling may be PC5-RRC signaling.
Step 902, reselecting the relay user equipment is triggered according to the third indication signaling.

In the present disclosure, the first user equipment may know, according to the third indication signaling, that the third SL-RSRP or the third SD-RSRP between the second user equipment and the current relay user equipment is less than or equal to the third preset threshold, and thus the first user equipment may trigger reselecting the relay user equipment.

In some examples, in a case where the third indication signaling indicates the first user equipment to trigger reselecting the relay user equipment, the first user equipment may trigger reselecting the relay user equipment according to the third indication signaling.

In the embodiment of the present disclosure, the first user equipment may obtain the third indication signaling transmitted by the second user equipment and trigger reselecting the relay user equipment according to the third indication signaling. Accordingly, the current relay user equipment may notify, in response to detecting that the third SL-RSRP or the third SD-RSRP of the link between the current relay user equipment and the second user equipment is less than or equal to the third preset threshold, the first user equipment to trigger reselecting the relay user equipment, so that resources of the second user equipment may be saved by preventing the first user equipment and the second user equipment from repeatedly reselecting the relay user equipment.

Please refer to FIG. 10, FIG. 10 is a schematic flowchart of a method for selecting or reselecting a relay user equipment provided by another embodiment of the present disclosure. The method is performed by a first user equipment. As shown in FIG. 10, the method may include but is not limited to steps 1001 to 1002.
Step 1001, fourth indication signaling transmitted by a current relay user equipment is obtained, where the fourth indication signaling indicates occurrence of a SL-RLF for a link between a second user equipment and the current relay user equipment.

In the present disclosure, the first user equipment may be a user equipment for transmitting a DCR message, and the second user equipment may be a user equipment for transmitting a DCA message. Alternatively, the second user equipment may also be the user equipment for transmitting the DCR message, and the first user equipment may be the user equipment for transmitting the DCA message. In other words, in a case where the first user equipment is a source remote user equipment, the second user equipment is a target remote user equipment. In a case where the second user equipment is the source remote user equipment, the first user equipment is the target remote user equipment.

In the present disclosure, the current relay user equipment may transmit the fourth indication signaling to the first user equipment in response to detecting occurrence of the SL-RLF for the link between the second user equipment and the current relay user equipment. The fourth indication signaling may indicate that the SL-RLF for the link between the second user equipment and the current relay user equipment occurs, or the fourth indication signaling may indicate the first user equipment to trigger reselecting the relay user equipment.

In some examples, the fourth indication signaling may be PC5-RRC signaling.
Step 1002, reselecting the relay user equipment is triggered according to the fourth indication signaling.

In the present disclosure, the first user equipment may know, according to the fourth indication signaling, that the SL-RLF for the link between the current relay user equipment and the second user equipment occurs, and thus the first user equipment may trigger reselecting the relay user equipment.

In some examples, in a case where the fourth indication signaling indicates the first user equipment to trigger reselecting the relay user equipment, the first user equipment may trigger reselecting the relay user equipment according to the fourth indication signaling.

In the embodiment of the present disclosure, the first user equipment may obtain the fourth indication signaling transmitted by the current relay user equipment and trigger reselecting the relay user equipment according to the fourth indication signaling. Accordingly, the current relay user equipment may notify, in response to detecting the occurrence of the SL-RLF for the link between the current relay user equipment and the second user equipment, the first user equipment to trigger reselecting the relay user equipment, so that resources of the second user equipment may be saved by preventing the first user equipment and the second user equipment from repeatedly reselecting the relay user equipment.

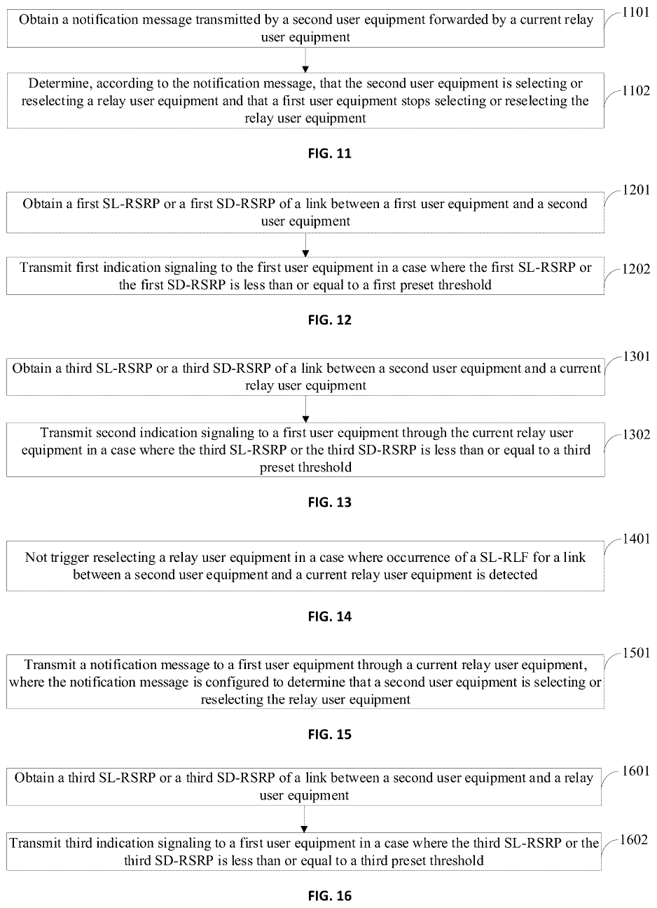

Please refer to FIG. 11, FIG. 11 is a schematic flowchart of a method for selecting or reselecting a relay user equipment provided by another embodiment of the present disclosure. The method is performed by a first user equipment. As shown in FIG. 11, the method may include but is not limited to steps 1101 to 1102.

Step 1101, a notification message transmitted by a second user equipment forwarded by a current relay user equipment is obtained.

In the present disclosure, the first user equipment may be a user equipment for transmitting a DCR message, and the second user equipment may be a user equipment for transmitting a DCA message. Alternatively, the second user equipment may also be the user equipment for transmitting the DCR message, and the first user equipment may be the user equipment for transmitting the DCA message. In other words, in a case where the first user equipment is a source remote user equipment, the second user equipment is a target remote user equipment. In a case where the second user equipment is the source remote user equipment, the first user equipment is the target remote user equipment.

In the present disclosure, both the first user equipment and the second user equipment may trigger selecting or reselecting the relay terminal. The second user equipment may forward the notification message to the first user equipment through the current relay user equipment. The notification message may be configured to determine that the second user equipment is selecting or reselecting the relay user equipment.

In some examples, the notification message may be any one of: a discovery request message; a discovery response message; a DCR message; or a DCA message. In some examples, the notification message may also be other messages, which is not limited in the present embodiment.
Step 1102, determining, according to the notification message, that the second user equipment is selecting or reselecting the relay user equipment and that the first user equipment stops selecting or reselecting the relay user equipment.

In the present disclosure, according to the notification message, the first user equipment may determine that the second user equipment is selecting or reselecting the relay user equipment. In this case, the first user equipment may stop selecting or reselecting the relay user equipment.

In the embodiment of the present disclosure, the first user equipment may obtain the notification message transmitted by the second user equipment forwarded by the current relay user equipment. According to the notification message, the first user equipment determine that the second user equipment is selecting or reselecting the relay user equipment, and then the first user equipment stops selecting or reselecting the relay user equipment. Accordingly, in a case where the second user equipment triggers selecting or reselecting the relay user equipment, the notification message may be forwarded to the first user equipment through the current relay user equipment, so as to cause the first user equipment to stop selecting or reselecting the relay user equipment, so that resources of the first user equipment may be saved by preventing the first user equipment and the second user equipment from repeatedly selecting or reselecting the relay user equipment.

Please refer to FIG. 12, FIG. 12 is a schematic flowchart of a method for selecting or reselecting a relay user equipment provided by another embodiment of the present disclosure. The method is performed by a second user equipment. As shown in FIG. 12, the method may include but is not limited to steps 1201 to 1202.
Step 1201, a first SL-RSRP or a first SD-RSRP of a link between a first user equipment and the second user equipment is obtained.

In the present disclosure, the first user equipment may be a user equipment for transmitting a DCR message, and the second user equipment may be a user equipment for transmitting a DCA message. Alternatively, the second user equipment may also be the user equipment for transmitting the DCR message, and the first user equipment may be the user equipment for transmitting the DCA message. In other words, in a case where the first user equipment is a source remote user equipment, the second user equipment is a target remote user equipment. In a case where the second user equipment is the source remote user equipment, the first user equipment is the target remote user equipment.

In the present disclosure, the method for obtaining the first SL-RSRP or the first SD-RSRP of the link between the first user equipment and the second user equipment by the second user equipment is similar to the method for obtaining the first SL-RSRP or the first SD-RSRP of the link between the first user equipment and the second user equipment by the first user equipment in the above-mentioned embodiment, so repetitions are avoided.
Step 1202, first indication signaling is transmitted to the first user equipment in a case where the first SL-RSRP or the first SD-RSRP is less than or equal to a first preset threshold.

In the present disclosure, in a case where the first SL-RSRP or the first SD-RSRP is less than or equal to the first preset threshold, the second user equipment may transmit the first indication signaling to the first user equipment. The first indication signaling may indicate that the first SL-RSRP or the first SD-RSRP is less than or equal to the first preset threshold, or the first indication signaling may directly indicate the first user equipment to trigger selecting the relay user equipment. The first user equipment may trigger selecting the relay user equipment in a case of receiving the first indication signaling transmitted by the second user equipment.

In some examples, the first indication signaling may be PC5-RRC signaling.

In the embodiment of the present disclosure, the second user equipment may obtain the first SL-RSRP or the first SD-RSRP of the link between the first user equipment and the second user equipment, and may transmit the first indication signaling to the first user equipment in a case where the first SL-RSRP or the first SD-RSRP is less than or equal to the first preset threshold. Accordingly, the second user equipment may notify, in response to detecting that the first SL-RSRP or the first SD-RSRP of the link between the first user equipment and the second user equipment is less than or equal to the first preset threshold, the first user equipment to trigger selecting the relay user equipment, so that resources of the second user equipment may be saved by preventing the first user equipment and the second user equipment from repeatedly selecting the relay user equipment.

Please refer to FIG. 13, FIG. 13 is a schematic flowchart of a method for selecting or reselecting a relay user equipment provided by another embodiment of the present disclosure. The method is performed by a second user equipment. As shown in FIG. 13, the method may include but is not limited to steps 1301 to 1302.
Step 1301, a third SL-RSRP or a third SD-RSRP of a link between the second user equipment and a current relay user equipment is obtained.

In the present disclosure, the method for obtaining the third SL-RSRP or the third SD-RSRP of the link between the second user equipment and the current relay user equipment by the second user equipment is similar to the method for obtaining the first SL-RSRP or the first SD-RSRP of the link between the first user equipment and the second user equipment by the first user equipment in the above-mentioned embodiment, so repetitions are avoided.

In the present disclosure, the first user equipment may be a user equipment for transmitting a DCR message, and the second user equipment may be a user equipment for transmitting a DCA message. Alternatively, the second user equipment may also be the user equipment for transmitting the DCR message, and the first user equipment may be the user equipment for transmitting the DCA message. In other words, in a case where the first user equipment is a source remote user equipment, the second user equipment is a target remote user equipment. In a case where the second user equipment is the source remote user equipment, the first user equipment is the target remote user equipment.
Step 1302, second indication signaling is transmitted to the first user equipment through the current relay user equipment in a case where the third SL-RSRP or the third SD-RSRP is less than or equal to a third preset threshold.

In the present disclosure, in a case where the third SL-RSRP or the third SD-RSRP is less than or equal to the third preset threshold, the second indication signaling may be forwarded to the first user equipment through the relay user equipment. The second indication signaling may indicate that the third SL-RSRP or the third SD-RSRP of the link between the second user equipment and the current relay user equipment is less than or equal to the third preset threshold, or the second indication signaling may directly indicate the first user equipment to trigger reselecting the relay user equipment.

In other words, the second user equipment may forward the second indication signaling to the first user equipment through the current relay user equipment in response to detecting that the third SL-RSRP or the third SD-RSRP of the link between the second user equipment and the current relay user equipment is less than or equal to the third preset threshold, so as to cause the first user equipment to trigger reselecting the relay user equipment.

In some examples, the second indication signaling may be PC5-RRC signaling.

In the embodiment of the present disclosure, the second user equipment may obtain the third SL-RSRP or the third SD-RSRP of the link between the second user equipment and the current relay user equipment, and may transmit the second indication signaling to the first user equipment through the current relay user equipment in a case where the third SL-RSRP or the third SD-RSRP is less than or equal to the third preset threshold. Accordingly, in response to detecting that the third SL-RSRP or the third SD-RSRP of the link between the second user equipment and the current relay user equipment is less than or equal to the third preset threshold, the second user equipment may notify, through the relay user equipment, the first user equipment to trigger reselecting the relay user equipment, so that resources of the second user equipment may be saved by preventing the first user equipment and the second user equipment from repeatedly reselecting the relay user equipment.

Please refer to FIG. 14, FIG. 14 is a schematic flowchart of a method for selecting or reselecting a relay user equipment provided by another embodiment of the present disclosure. The method is performed by a second user equipment. As shown in FIG. 14, the method may include but is not limited to step 1401.
Step 1401, not triggering reselecting the relay user equipment in a case where occurrence of a SL-RLF for a link between the second user equipment and a current relay user equipment is detected.

In the present disclosure, the second user equipment may not trigger reselecting the relay user equipment in a case where the occurrence of the SL-RLF for the link between the second user equipment and the current relay user equipment is detected, and may wait for the current relay user equipment to detect and notify the occurrence of the SL-RLF for the link between the second user equipment and the current relay user equipment to the first user equipment. Then the first user equipment triggers reselecting the relay user equipment.

In the present disclosure, the first user equipment may be a user equipment for transmitting a DCR message, and the second user equipment may be a user equipment for transmitting a DCA message. Alternatively, the second user equipment may also be the user equipment for transmitting the DCR message, and the first user equipment may be the user equipment for transmitting the DCA message. In other words, in a case where the first user equipment is a source remote user equipment, the second user equipment is a target remote user equipment. In a case where the second user equipment is the source remote user equipment, the first user equipment is the target remote user equipment.

In the embodiment of the present disclosure, the second user equipment may not trigger reselecting the relay user equipment in a case where the occurrence of the SL-RLF for the link between the second user equipment and the current relay user equipment is detected. Accordingly, resources of the second user equipment may be saved by preventing the first user equipment and the second user equipment from repeatedly reselecting the relay user equipment.

Please refer to FIG. 15, FIG. 15 is a schematic flowchart of a method for selecting or reselecting a relay user equipment provided by another embodiment of the present disclosure. The method is performed by a second user equipment. As shown in FIG. 15, the method may include but is not limited to step 1501.
Step 1501, a notification message is transmitted to a first user equipment through a current relay user equipment, where the notification message is configured to determine that the second user equipment is selecting or reselecting the relay user equipment.

In the present disclosure, the first user equipment may be a user equipment for transmitting a DCR message, and the second user equipment may be a user equipment for transmitting a DCA message. Alternatively, the second user equipment may also be the user equipment for transmitting the DCR message, and the first user equipment may be the user equipment for transmitting the DCA message. In other words, in a case where the first user equipment is a source remote user equipment, the second user equipment is a target remote user equipment. In a case where the second user equipment is the source remote user equipment, the first user equipment is the target remote user equipment.

In the present disclosure, both the first user equipment and the second user equipment may trigger selecting or reselecting the relay terminal. The second user equipment may forward the notification message to the first user equipment through the current relay user equipment. The notification message may be configured to determine that the second user equipment is selecting or reselecting the relay user equipment. According to the notification message, the first user equipment may determine that the second user equipment is selecting or reselecting the relay user equipment. In this case, the first user equipment may stop selecting or reselecting the relay user equipment.

In some examples, the notification message may be any one of: a discovery request message; a discovery response message; a DCR message; or a DCA message. In some examples, the notification message may also be other messages, which is not limited in the present embodiment.

In the embodiment of the present disclosure, the second user equipment may transmit the notification message to the first user equipment through the current relay user equipment. Accordingly, in a case where the second user equipment triggers selecting or reselecting the relay user equipment, the notification message may be forwarded to the first user equipment through the current relay user equipment, so as to cause the first user equipment to stop selecting or reselecting the relay user equipment, so that resources of the first user equipment may be saved by preventing the first user equipment and the second user equipment from repeatedly selecting or reselecting the relay user equipment.

Please refer to FIG. 16, FIG. 16 is a schematic flowchart of a method for selecting or reselecting a relay user equipment provided by another embodiment of the present disclosure. The method is performed by a relay user equipment. As shown in FIG. 16, the method may include but is not limited to steps 1601 to 1602.
Step 1601, a third SL-RSRP or a third SD-RSRP of a link between a second user equipment and the relay user equipment is obtained.

In the present disclosure, the first user equipment may be a user equipment for transmitting a DCR message, and the second user equipment may be a user equipment for transmitting a DCA message. Alternatively, the second user equipment may also be the user equipment for transmitting the DCR message, and the first user equipment may be the user equipment for transmitting the DCA message. In other words, in a case where the first user equipment is a source remote user equipment, the second user equipment is a target remote user equipment. In a case where the second user equipment is the source remote user equipment, the first user equipment is the target remote user equipment.

In the present disclosure, the method for obtaining the third SL-RSRP or the third SD-RSRP of the link between the second user equipment and the relay user equipment by the relay user equipment is similar to the method for obtaining the first SL-RSRP or the first SD-RSRP of the link between the first user equipment and the second user equipment by the first user equipment in the above-mentioned embodiment, so repetitions are avoided.
Step 1602, third indication signaling is transmitted to the first user equipment in a case where the third SL-RSRP or the third SD-RSRP is less than or equal to a third preset threshold.

In the present disclosure, in a case where the third SL-RSRP or the third SD-RSRP is less than or equal to the third preset threshold, the relay user equipment may transmit the third indication signaling to the first user equipment. The third indication signaling may indicate that the third SL-RSRP or the third SD-RSRP of the link between the second user equipment and the current relay user equipment is less than or equal to the third preset threshold, or the third indication signaling may directly indicate the first user equipment to trigger reselecting the relay user equipment. The first user equipment may reselect the relay user equipment in a case of receiving the third indication signaling transmitted by the relay user equipment.

In some examples, the third indication signaling may be PC5-RRC signaling.

In the embodiment of the present disclosure, the relay user equipment may obtain the third SL-RSRP or the third SD-RSRP of the link between the second user equipment and the relay user equipment, and may transmit the third indication signaling to the first user equipment in a case where the third SL-RSRP or the third SD-RSRP is less than or equal to the third preset threshold. Accordingly, the current relay user equipment may notify, in response to detecting that the third SL-RSRP or the third SD-RSRP of the link between the current relay user equipment and the second user equipment is less than or equal to the third preset threshold, the first user equipment to trigger reselecting the relay user equipment, so that resources of the second user equipment may be saved by preventing the first user equipment and the second user equipment from repeatedly reselecting the relay user equipment.

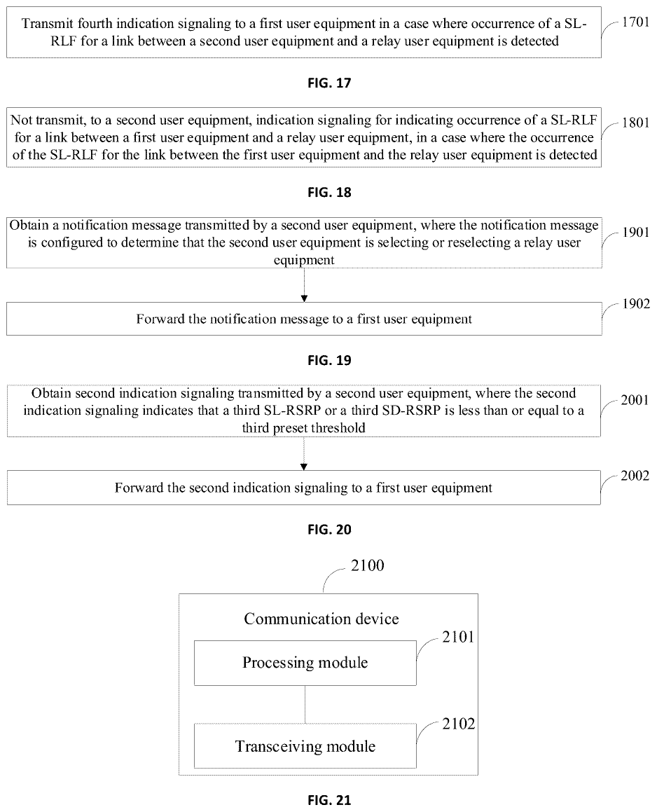

Please refer to FIG. 17, FIG. 17 is a schematic flowchart of a method for selecting or reselecting a relay user equipment provided by another embodiment of the present disclosure. The method is performed by a relay user equipment. As shown in FIG. 17, the method may include but is not limited to step 1701.
Step 1701, fourth indication signaling is transmitted to a first user equipment in a case where occurrence of a SL-RLF for a link between a second user equipment and the relay user equipment is detected.

In the present disclosure, the first user equipment may be a user equipment for transmitting a DCR message, and the second user equipment may be a user equipment for transmitting a DCA message. Alternatively, the second user equipment may also be the user equipment for transmitting the DCR message, and the first user equipment may be the user equipment for transmitting the DCA message. In other words, in a case where the first user equipment is a source remote user equipment, the second user equipment is a target remote user equipment. In a case where the second user equipment is the source remote user equipment, the first user equipment is the target remote user equipment.

In the present disclosure, the relay user equipment may transmit the fourth indication signaling to the first user equipment in a case where the occurrence of the SL-RLF for the link between the second user equipment and the current relay user equipment is detected. The fourth indication signaling may indicate that the SL-RLF for the link between the second user equipment and the relay user equipment occurs, or the fourth indication signaling may indicate the first user equipment to trigger reselecting the relay user equipment. The first user equipment may reselect the relay user equipment in a case of receiving the fourth indication signaling.

In some examples, the fourth indication signaling may be PC5-RRC signaling.

In the embodiment of the present disclosure, the relay user equipment may transmit the fourth indication signaling to the first user equipment in a case where the occurrence of the SL-RLF for the link between the second user equipment and the relay user equipment is detected. Accordingly, the relay user equipment may notify, in a case where the occurrence of the SL-RLF for the link between the relay user equipment and the second user equipment is detected, the first user equipment to trigger reselecting the relay user equipment, so that resources of the second user equipment may be saved by preventing the first user equipment and the second user equipment from repeatedly reselecting the relay user equipment.

Please refer to FIG. 18, FIG. 18 is a schematic flowchart of a method for selecting or reselecting a relay user equipment provided by another embodiment of the present disclosure. The method is performed by a relay user equipment. As shown in FIG. 18, the method may include but is not limited to step 1801.
Step 1801, not transmitting, to a second user equipment, indication signaling for indicating occurrence of a SL-RLF for a link between a first user equipment and the relay user equipment, in a case where the occurrence of the SL-RLF for the link between the first user equipment and the relay user equipment is detected.

In the present disclosure, the first user equipment may be a user equipment for transmitting a DCR message, and the second user equipment may be a user equipment for transmitting a DCA message. Alternatively, the second user equipment may also be the user equipment for transmitting the DCR message, and the first user equipment may be the user equipment for transmitting the DCA message. In other words, in a case where the first user equipment is a source remote user equipment, the second user equipment is a target remote user equipment. In a case where the second user equipment is the source remote user equipment, the first user equipment is the target remote user equipment.

In the present disclosure, in a case where the occurrence of the SL-RLF for the link between the first user equipment and the relay user equipment is detected, the relay user equipment may not transmit, to the second user equipment, the indication signaling for indicating that the SL-RLF for the link between the first user equipment and the relay user equipment occurs, and may wait for the first user equipment to discover the occurrence of the SL-RLF for the link between the first user equipment and the relay user equipment by the first user equipment itself. Then the first user equipment self-triggers reselecting the relay terminal.

In the embodiment of the present disclosure, in a case where the occurrence of the SL-RLF for the link between the first user equipment and the relay user equipment is detected, the relay user equipment does not transmit, to the second user equipment, the indication signaling for indicating that the SL-RLF for the link between the first user equipment and the relay user equipment occurs. Accordingly, device resources may be saved by preventing the first user equipment and the second user equipment from repeatedly reselecting the relay user equipment.

Please refer to FIG. 19, FIG. 19 is a schematic flowchart of a method for selecting or reselecting a relay user equipment provided by another embodiment of the present disclosure. The method is performed by a relay user equipment. As shown in FIG. 19, the method may include but is not limited to steps 1901 to 1902.
Step 1901, a notification message transmitted by a second user equipment is obtained, where the notification message is configured to determine that the second user equipment is selecting or reselecting the relay user equipment.

In the present disclosure, a first user equipment may be a user equipment for transmitting a DCR message, and the second user equipment may be a user equipment for transmitting a DCA message. Alternatively, the second user equipment may also be the user equipment for transmitting the DCR message, and the first user equipment may be the user equipment for transmitting the DCA message. In other words, in a case where the first user equipment is a source remote user equipment, the second user equipment is a target remote user equipment. In a case where the second user equipment is the source remote user equipment, the first user equipment is the target remote user equipment.

In the present disclosure, both the first user equipment and the second user equipment may trigger selecting or reselecting the relay terminal. The second user equipment may transmit the notification message to the relay user equipment, so as to cause the relay user equipment to obtain the notification message transmitted by the second user equipment. The notification message may be configured to determine that the second user equipment is selecting or reselecting the relay user equipment.

In some examples, the notification message may be any one of: a discovery request message; a discovery response message; a DCR message; or a DCA message. In some examples, the notification message may also be other messages, which is not limited in the present embodiment.
Step 1902, the notification message is forwarded to the first user equipment.

In the present disclosure, the relay user equipment may forward, to the first user equipment, the notification message transmitted by the second user equipment. The first user equipment may determine that the second user equipment is selecting or reselecting the relay user equipment according to the notification message. In this case, the first user equipment may stop selecting or reselecting the relay user equipment.

In the embodiment of the present disclosure, the relay user equipment may obtain the notification message transmitted by the second user equipment and may forward the notification message to the first user equipment. Accordingly, in a case where the second user equipment triggers selecting or reselecting the relay user equipment, the notification message may be forwarded to the first user equipment through the current relay user equipment, so as to cause the first user equipment to stop selecting or reselecting the relay user equipment, so that resources of the first user equipment may be saved by preventing the first user equipment and the second user equipment from repeatedly selecting or reselecting the relay user equipment.

Please refer to FIG. 20, FIG. 20 is a schematic flowchart of a method for selecting or reselecting a relay user equipment provided by another embodiment of the present disclosure. The method is performed by a relay user equipment. As shown in FIG. 20, the method may include but is not limited to steps 2001 to 2002.
Step 2001, second indication signaling transmitted by a second user equipment is obtained, where the second indication signaling indicates that a third SL-RSRP or a third SD-RSRP is less than or equal to a third preset threshold.

In the present disclosure, a first user equipment may be a user equipment for transmitting a DCR message, and the second user equipment may be a user equipment for transmitting a DCA message. Alternatively, the second user equipment may also be the user equipment for transmitting the DCR message, and the first user equipment may be the user equipment for transmitting the DCA message. In other words, in a case where the first user equipment is a source remote user equipment, the second user equipment is a target remote user equipment. In a case where the second user equipment is the source remote user equipment, the first user equipment is the target remote user equipment.

In the present disclosure, the second user equipment may obtain the third SL-RSRP or the third SD-RSRP of a link between the second user equipment and a current relay user equipment, and may transmit the second indication signaling to the relay user equipment in a case where the third SL-RSRP or the third SD-RSRP is less than or equal to the third preset threshold, so as to cause the relay user equipment to obtain the second indication signaling transmitted by the second user equipment. The second indication signaling may indicate that the third SL-RSRP or the third SD-RSRP of a link between the second user equipment and the relay user equipment is less than or equal to the third preset threshold, or the second indication signaling may directly indicate the first user equipment to trigger reselecting the relay user equipment.
Step 2002, the second indication signaling is forwarded to the first user equipment.

In the present disclosure, the relay user equipment may forward the second indication signaling to the first user equipment. The first user equipment may trigger reselecting the relay user equipment in a case of receiving the second indication signaling.

In the embodiment of the present disclosure, the relay user equipment may obtain the second indication signaling transmitted by the second user equipment, and may forward the second indication signaling to the first user equipment. Accordingly, in response to detecting that the third SL-RSRP or the third SD-RSRP of the link between the second user equipment and the current relay user equipment is less than or equal to the third preset threshold, the second user equipment may notify, through the current relay user equipment, the first user equipment to trigger reselecting the relay user equipment, so that resources of the second user equipment may be saved by preventing the first user equipment and the second user equipment from repeatedly reselecting the relay user equipment.

It is to be noted that in the present disclosure, the first preset threshold, the second preset threshold and the third preset threshold may be the same or not. The first preset threshold, the second preset threshold and the third preset threshold may be configured or pre-configured by a network device.

For example, a user equipment in an RRC connected state may obtain the first preset threshold, the second preset threshold and the third preset threshold from the network device through dedicated RRC signaling. A user equipment in an RRC idle state may obtain the first preset threshold, the second preset threshold and the third preset threshold from the network device through a system information block (SIB). A user equipment out of a network coverage may obtain the first preset threshold, the second preset threshold and the third preset threshold according to a pre-configuring mode.

In order to better understand the method for selecting or reselecting the relay user equipment (UE) in the present disclosure, descriptions are made with reference to the following embodiment.

In some examples, merely a source remote UE may trigger at least one of selecting the relay UE or reselecting the relay UE.

In some examples, the source remote UE is a UE for transmitting a DCR in a U2U scenario. In some examples, the source remote UE and a target remote UE may be referred to as other names, for example, a source U2U end terminal and a target U2U end terminal, or the like.

In some examples, the source remote UE detects that a SL-RSRP or a SD-RSRP of a link between the source remote UE and the target remote UE is less than or equal to a preset threshold, and then the source remote UE triggers selecting the relay UE. The source remote UE detects occurrence of a SL-RLF for the link between the source remote UE and the target remote UE, and then the source remote UE triggers selecting the relay UE. The source remote UE detects that a SL-RSRP or a SD-RSRP of a link between the source remote UE and the relay UE is less than or equal to a preset threshold, and then the source remote UE triggers reselecting the relay UE. The source remote UE detects occurrence of a SL-RLF for the link between the source remote UE and the relay UE, and then the source remote UE triggers reselecting the relay UE.

In some examples, in a case where data transmission exists between the source remote UE and the target remote UE, the source remote UE compares the obtained SL-RSRP with the preset threshold. In a case where no data transmission exists between the source remote UE and the target remote UE, the source remote UE compares one of a SL-RSRP/SD-RSRP with the preset threshold.

In some examples, the target remote UE detects that a SL-RSRP or a SD-RSRP of a link between the source remote UE and the target remote UE is less than or equal to a preset threshold, and then the target remote UE notifies, through PC5 signaling, the source remote UE to trigger selecting the relay UE.

In some examples, the PC5 signaling may be PC5-RRC signaling, for example, may be indication signaling, which indicates that the SL-RSRP or the SD-RSRP of the link between the source remote UE and the target remote UE is less than or equal to the preset threshold. The source remote UE triggers selecting the relay terminal in a case of receiving the indication signaling.

In some examples, the target remote UE detects that a SL-RSRP or a SD-RSRP of a link between the target remote UE and the relay UE is less than or equal to a preset threshold, and then notifies, through the relay UE, the source remote UE to trigger reselecting the relay UE.

In some examples, the target remote UE forwards PC5-RRC indication signaling to the source remote UE through the relay UE. The indication signaling indicates that the SL-RSRP or the SD-RSRP of the link between the target remote UE and the relay UE is less than or equal to the preset threshold. The source remote UE triggers reselecting the relay UE in a case of receiving the indication signaling.

In some examples, the relay UE detects that the SL-RSRP or the SD-RSRP of the link between the target remote UE and the relay UE is less than or equal to a preset threshold, and then the target remote UE notifies, through PC5 signaling, the source remote UE to trigger reselecting the relay terminal.

In some examples, the PC5 signaling may be PC5-RRC signaling, for example, may be indication signaling, which indicates that the SL-RSRP or the SD-RSRP of the link between the target remote UE and the relay UE is less than or equal to the preset threshold. The source remote UE triggers reselecting the relay UE in a case of receiving the indication signaling.

In some examples, the relay UE detects occurrence of a SL-RLF for the link between the target remote UE and the relay UE, and then the relay UE notifies, through the PC5 signaling, the source remote UE to trigger reselecting the relay UE.

In some examples, the PC5 signaling may be PC5-RRC signaling, for example, may be indication signaling, which indicates that a SL-RLF for the link between the target remote UE and the relay UE occurs. The source remote UE triggers reselecting the relay UE in a case of receiving the indication signaling.

In some examples, the relay UE detects occurrence of a SL-RLF for the link between the source remote UE and the relay UE, and then the relay UE does not notify the target remote UE through the PC5 signaling.

In some examples, in combination with the fourth embodiment, a SL-RLF indication information transmitted by the relay UE is transmitted merely to the source remote UE, namely, the UE for transmitting a DCR. In a case where the relay UE detects occurrence of a SL-RLF for the link between the source remote UE and the relay UE, the relay UE does not notify the target remote UE through the PC5 signaling, and may wait for the source remote terminal to discover the occurrence of the SL-RLF for the link between the source remote UE and the relay UE by the source remote terminal itself. Then the source remote UE self-triggers reselecting the relay UE.

In some examples, the target remote UE detects occurrence of a SL-RLF for the link between the target remote UE and the relay UE, and then the target remote UE does not trigger reselecting the relay UE.

In some examples, in a case where the target remote UE detects the occurrence of the SL-RLF for the link between the target remote UE and the relay UE, the target remote UE does not trigger reselecting the relay terminal, and waits for the relay UE to discover and notify to the source remote UE, through a manner in a fifth example above, that the target remote UE detects the occurrence of the SL-RLF for the link between the target remote UE and the relay UE. Then the source remote UE triggers reselecting the relay UE.

In some examples, the source remote UE may be replaced by the target remote UE, the target remote UE may be replaced by the source remote UE, that is, there is merely a solution that the target remote UE may trigger selecting or reselecting the relay UE.

In some examples, both the source remote UE and the target remote UE may trigger selecting/reselecting the relay UE. The source remote UE or the target remote UE receives a PC5 message transmitted by the target remote UE or the source remote UE forwarded by the relay UE, and then determines that the target remote UE or the source remote UE is selecting/reselecting the relay UE, so the source remote UE or the target remote UE stops selecting/reselecting the relay UE.

In some examples, the PC5 message may be a discovery request message, a discovery response message, a DCR message, or a DCA message, which is not limited.

Please refer to FIG. 21, FIG. 21 is a schematic structural diagram of a communication device 2100 provided by an embodiment of the present disclosure. The communication device 2100 shown in FIG. 21 may include a processing module 2101 and a transceiving module 2102. The transceiving module 2102 may include at least one of a transmitting module (not shown) or a receiving module (not shown), the transmitting module is configured to implement a transmitting function, the receiving module is configured to implement a receiving function, and the transceiving module 2102 may implement at least one of the transmitting function or the receiving function.

It may be understood that the communication device 2100 may be a first user equipment or a device in the first user equipment, or a device matching the first user equipment for use.

The communication device 2100 is a first user equipment, where:
the processing module 2101 is configured to trigger selecting or reselecting a relay user equipment in a case where a condition for triggering selecting or reselecting the relay user equipment is satisfied.

In some examples, the processing module 2101 is configured to:
obtain a first sidelink reference signal receiving power (SL-RSRP) or a first sidelink discovery reference signal receiving power (SD-RSRP) of a link between the first user equipment and a second user equipment; and
trigger selecting the relay user equipment in a case where the first SL-RSRP or the first SD-RSRP is less than or equal to a first preset threshold.

In some examples, the processing module 2101 is configured to:
obtain the first SL-RSRP in a case where data transmission exists between the first user equipment and the second user equipment; and
obtain the first SL-RSRP or the first SD-RSRP in a case where no data transmission exists between the first user equipment and the second user equipment.

In some examples, the processing module 2101 is configured to trigger selecting the relay user equipment in response to detecting occurrence of a sidelink radio link failure (SL-RLF) for the link between the first user equipment and the second user equipment.

In some examples, the processing module 2101 is configured to:
obtain a second SL-RSRP or a second SD-RSRP of a link between the first user equipment and a current relay user equipment; and
trigger reselecting the relay user equipment in a case where the second SL-RSRP or the second SD-RSRP is less than or equal to a second preset threshold.

In some examples, the processing module 2101 is configured to:
trigger reselecting the relay user equipment in response to detecting occurrence of a SL-RLF for a link between the first user equipment and a current relay user equipment.

In some examples, the communication device 2100 may further include:
a transceiving module 2102, configured to obtain first indication signaling transmitted by a second user equipment, where the first indication signaling indicates that a first SL-RSRP or a first SD-RSRP of a link between the first user equipment and the second user equipment is less than or equal to a first preset threshold; and
a processing module 2101, configured to trigger selecting the relay user equipment according to the first indication signaling.

In some examples, the transceiving module 2102 is configured to obtain second indication signaling transmitted by a second user equipment forwarded by a current relay user equipment, where the second indication signaling indicates that a third SL-RSRP or a third SD-RSRP of a link between the second user equipment and the current relay user equipment is less than or equal to a third preset threshold; and
the processing module 2101 is configured to trigger reselecting the relay user equipment according to the second indication signaling.

In some examples, the transceiving module 2102 is configured to obtain third indication signaling transmitted by a current relay user equipment, where the third indication signaling indicates that a third SL-RSRP or a third SD-RSRP of a link between a second user equipment and the current relay user equipment is less than or equal to a third preset threshold; and
the processing module 2101 is configured to trigger reselecting the relay user equipment according to the third indication signaling.

In some examples, the transceiving module 2102 is configured to obtain fourth indication signaling transmitted by a current relay user equipment, where the fourth indication signaling indicates occurrence of a SL-RLF for a link between a second user equipment and the current relay user equipment; and
the processing module 2101 is configured to trigger reselecting the relay user equipment according to the fourth indication signaling.

In some examples, the transceiving module 2102 is configured to obtain a notification message transmitted by a second user equipment forwarded by a current relay user equipment; and
the processing module 2101 is configured to determine, according to the notification message, that the second user equipment is selecting or reselecting the relay user equipment and that the first user equipment stops selecting or reselecting the relay user equipment.

In some examples, the notification message is any one of: a discovery request message; a discovery response message; a direct communication request (DCR) message; or a direct communication accept (DCA) message.

In some examples, the first user equipment is a user equipment for transmitting the DCR message, and the second user equipment is a user equipment for transmitting the direct communication accept (DCA) message. Alternatively, the second user equipment is the user equipment for transmitting the DCR message, and the first user equipment is the user equipment for transmitting the direct communication accept (DCA) message.

In the present disclosure, the first user equipment may select or reselect the relay user equipment in a case where a condition for triggering selecting or reselecting the relay user equipment is satisfied, so that the first user equipment may select or reselect the relay user equipment in a case where the condition for triggering selecting or reselecting the relay user equipment is satisfied. In this way, device resources may be saved by avoiding repeatedly triggering selecting or reselecting the relay user equipment.

It may be understood that the communication device 2100 may be the second user equipment or a device in the second user equipment, or a device matching the second user equipment for use.

The communication device 2100 is a second user equipment, where:
the processing module 2101 is configured to obtain a first SL-RSRP or a first SD-RSRP of a link between a first user equipment and the second user equipment; and
the transceiving module 2102 is configured to transmit first indication signaling to the first user equipment in a case where the first SL-RSRP or the first SD-RSRP is less than or equal to the first preset threshold, where the first indication signaling indicates that the first SL-RSRP or the first SD-RSRP is less than or equal to the first preset threshold.

In some examples, the processing module 2101 is further configured to obtain a third SL-RSRP or a third SD-RSRP of a link between the second user equipment and the current relay user equipment; and
the transceiving module 2102 is further configured to transmit second indication signaling to the first user equipment through the current relay user equipment in a case where the third SL-RSRP or the third SD-RSRP is less than or equal to a third preset threshold, where the second indication signaling indicates that the third SL-RSRP or the third SD-RSRP is less than or equal to the third preset threshold.

In some examples, the processing module 2101 is further configured to not trigger reselecting the relay user equipment in a case where occurrence of a SL-RLF for a link between the second user equipment and a current relay user equipment is detected.

In some examples, the transceiving module 2102 is further configured to transmit a notification message to the first user equipment through a current relay user equipment, where the notification message is configured to determine that the second user equipment is selecting or reselecting the relay user equipment.

In some examples, the notification message is any one of: a discovery request message; a discovery response message; a direct communication request (DCR) message; or a DCA message.

In some examples, the first user equipment is a user equipment for transmitting the DCR message, and the second user equipment is a user equipment for transmitting the direct communication accept (DCA) message. Alternatively, the second user equipment is the user equipment for transmitting the DCR message, and the first user equipment is the user equipment for transmitting the direct communication accept (DCA) message.

In the present disclosure, the second user equipment may obtain the first SL-RSRP or the first SD-RSRP of the link between the first user equipment and the second user equipment, and may transmit the first indication signaling to the first user equipment in a case where the first SL-RSRP or the first SD-RSRP is less than or equal to the first preset threshold. Accordingly, the second user equipment may notify, in response to detecting that the first SL-RSRP or the first SD-RSRP of the link between the first user equipment and the second user equipment is less than or equal to the first preset threshold, the first user equipment to trigger selecting the relay user equipment, so that resources of the second user equipment may be saved by preventing the first user equipment and the second user equipment from repeatedly selecting the relay user equipment.

It may be understood that the communication device 2100 may be a relay user equipment, or a device in the relay user equipment, or a device capable of matching the relay user equipment for use.

The communication device 2100 is a relay user equipment, where:
the processing module 2101 is configured to obtain a third SL-RSRP or a third SD-RSRP of a link between a second user equipment and the relay user equipment; and
the transceiving module 2102 is configured to transmit third indication signaling to the first user equipment in a case where the third SL-RSRP or the third SD-RSRP is less than or equal to a third preset threshold, where the third indication signaling indicates that the third SL-RSRP or the third SD-RSRP is less than or equal to the third preset threshold.

In some examples, the transceiving module 2102 is further configured to transmit fourth indication signaling to the first user equipment in a case where occurrence of a SL-RLF for a link between the second user equipment and the relay user equipment is detected, where the fourth indication signaling indicates the occurrence of the SL-RLF for the link between the second user equipment and the relay user equipment.

In some examples, the transceiving module 2102 is further configured to not transmit, to the second user equipment, indication signaling for indicating occurrence of a SL-RLF for a link between the first user equipment and the relay user equipment, in a case where the occurrence of the SL-RLF for the link between the first user equipment and the relay user equipment is detected.

In some examples, the processing module 2101 is further configured to obtain a notification message transmitted by the second user equipment, where the notification message is configured to determine that the second user equipment is selecting or reselecting the relay user equipment; and the transceiving module 2102 is further configured to forward the notification message to the first user equipment.

In some examples, the notification message is any one of: a discovery request message; a discovery response message; a direct communication request (DCR) message; or a DCA message.

In some examples, the processing module 2101 is further configured to obtain second indication signaling transmitted by the second user equipment, where the second indication signaling indicates that the third SL-RSRP or the third SD-RSRP is less than or equal to the third preset threshold; and the transceiving module 2102 is further configured to forward the second indication signaling to the first user equipment.

In some examples, the first user equipment is a user equipment for transmitting the DCR message, and the second user equipment is a user equipment for transmitting the direct communication accept (DCA) message. Alternatively, the second user equipment is the user equipment for transmitting the DCR message, and the first user equipment is the user equipment for transmitting the direct communication accept (DCA) message.

In the present disclosure, the relay user equipment may obtain the third SL-RSRP or the third SD-RSRP of the link between the second user equipment and the relay user equipment, and may transmit the third indication signaling to the first user equipment in a case where the third SL-RSRP or the third SD-RSRP is less than or equal to the third preset threshold. Accordingly, the current relay user equipment notifies, in response to detecting that the third SL-RSRP or the third SD-RSRP of the link between the current relay user equipment and the second user equipment is less than or equal to the third preset threshold, the first user equipment to trigger reselecting the relay user equipment, so that resources of the second user equipment may be saved by preventing the first user equipment and the second user equipment from repeatedly reselecting the relay user equipment.

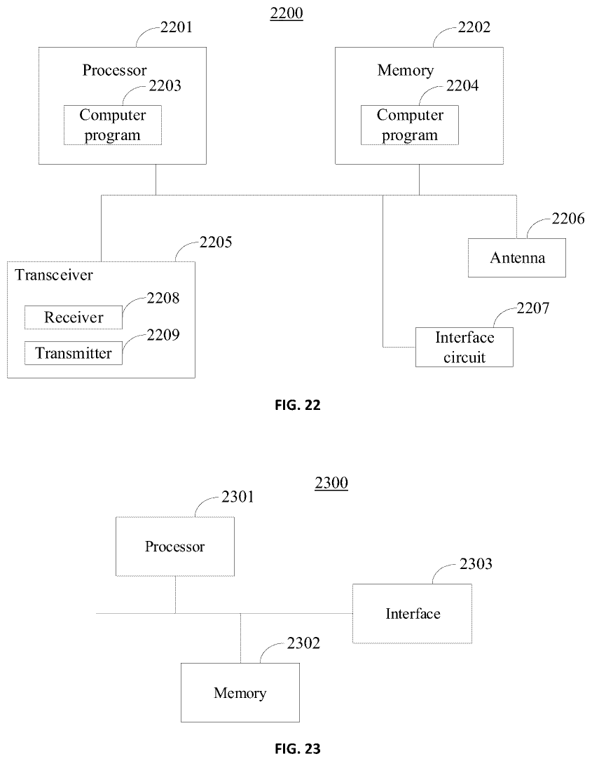

Please refer to FIG. 22, which is a schematic structural diagram of a communication device 2200 provided by another embodiment of the present disclosure. The communication device 2200 may be a network device or a user equipment, may also be a chip, a chip system, a processor or the like supporting the network device to implement the method, and may also be a chip, a chip system, a processor or the like supporting the user equipment to implement the method. The communication device may be configured to implement the method described in the method embodiment, which may refer to the description in the above-mentioned method embodiment in detail.

The communication device 2200 may include one or more processors 2201. The processor 2201 may be a general-purpose processor, a special-purpose processor or the like. For example, the processor may be a baseband processor or a central processing unit. The baseband processor may be configured to process a communication protocol and communication data, the central processing unit may be configured to control the communication device (such as a base station, a baseband chip, a terminal, a terminal chip, a DU, a CU or the like) to execute a computer program and process data of the computer program.

In some examples, the communication device 2200 may further include one or more memories 2202 which may store a computer program 2204, and the processor 2201 executes the computer program 2204 so as to cause the communication device 2200 to perform the method described in the method embodiment. In some examples, the memory 2202 may further store data. The communication device 2200 and the memory 2202 may be independently arranged or integrated.

In some examples, the communication device 2200 may further include a transceiver 2205 and an antenna 2206. The transceiver 2205 may be called a transceiving unit, a transmitter receiver, a transceiver circuit or the like and is configured to implement a transceiving function. The transceiver 2205 may include a receiver 2208 and a transmitter 2209, the receiver 2208 may be called a receiving machine, a receiving circuit or the like and configured to implement a receiving function; and the transmitter 2209 may be called a transmitting machine, a transmission circuit or the like and configured to implement a transmitting function.

In some examples, the communication device 2200 may further include one or more interface circuits 2207. The interface circuit 2207 is configured to receive a code instruction and transmit the code instruction to the processor 2201. The processor 2201 runs the code instruction so as to cause the communication device 2200 to perform the method described in the method embodiment.

The communication device 2200 is a first user equipment. The processor 2201 is configured to perform step 201 in FIG. 2; step 301 and step 302 in FIG. 3; step 401 in FIG. 4; step 501 and step 502 in FIG. 5; step 601 in FIG. 6; step 702 in FIG. 7; step 802 in FIG. 8; step 902 in FIG. 9; step 1002 in FIG. 10; step 1102 in FIG. 11; and the like.

The communication device 2200 is a second user equipment. The transceiver 2205 is configured to perform step 1202 in FIG. 12; step 1302 in FIG. 13; step 1501 in FIG. 15; step 1001 in FIG. 10; and step 1102 in FIG. 11.

In an implementation, the processor 2201 may include a transceiver (not shown) configured to implement receiving and transmitting functions. For example, the transceiver may be a transceiver circuit, an interface or an interface circuit. The transceiver circuit, the interface or the interface circuit configured to implement the receiving and transmitting functions may be separated or integrated. The transceiver circuit, interface or interface circuit may be configured to read and write code/data, or the transceiver circuit, interface or interface circuit may be configured to transmit or transfer a signal.

In an implementation, the processor 2201 may store a computer program 2203, and the computer program 2203 runs on the processor 2201 so as to cause the communication device 2200 to perform the method described in the method embodiment. The computer program 2203 may be firmed in the processor 2201, and in this case, the processor 2201 may be implemented by hardware.

In an implementation, the communication device 2200 may include a circuit (not shown), and the circuit may implement the transmitting, receiving or communication function in the method embodiment. The processor and the transceiver described in the present disclosure may be implemented on an integrated circuit (IC), an analog IC, a radio frequency integrated circuit (RFIC), a mixed signal IC, an application specific integrated circuit (ASIC), a printed circuit board (PCB), an electronic device or the like.

The processor and the transceiver may also be manufactured by various IC technologies, for example, a complementary metal oxide semiconductor (CMOS), an nMetal-oxide-semiconductor (NMOS), a positive channel metal oxide semiconductor (PMOS), a bipolar junction transistor (BJT), a bipolar CMOS (BiCMOS), a silicon germanium (SiGe), gallium arsenide (GaAs) or the like.

The communication device described in the embodiment may be the network device or a terminal, but a range of the communication device described in the present disclosure is not limited to this, and a structure of the communication device may be not limited by FIG. 22. The communication device may be an independent device or a part of a larger device. For example, the communication device may be:
(1) an independent integrated circuit (IC), chip, chip system or sub-system;
(2) a set with one or more ICs, in some examples, the IC set may also include a storage component configured to store data and a computer program;
(3) the ASIC, for example, a modem;
(4) a module capable of being embedded into another device;
(5) a receiver, a terminal, a smart terminal, a cell phone, a wireless device, a handset, a mobile unit, a vehicle-mounted device, a network device, a cloud device, an artificial intelligence device or the like; and
(6) others.

A case that the communication device may be the chip or the chip system may refer to a schematic structural diagram of a chip 2300 shown in FIG. 23. The chip 2300 shown in FIG. 23 includes a processor 2301, a memory 2302, and an interface 2303.

There may be one or more processors 2301 and a plurality of interfaces 2303.

In a case that the chip 2300 is configured to implement functions of a first user equipment in the embodiment of the present disclosure:
the interface 2303 is configured to perform step 801 in FIG. 8; step 901 in FIG. 9; step 1001 in FIG. 10; step 1101 in FIG. 11; and the like.

In a case that the chip 2300 is configured to implement functions of a second user equipment in the embodiment of the present disclosure:
the interface 2303 is configured to perform step 1202 in FIG. 12; step 1302 in FIG. 13; step 1501 in FIG. 15; step 1001 in FIG. 10; step 1102 in FIG. 11; and the like.

In a case that the chip 2300 is configured to implement functions of a relay user equipment in the embodiment of the present disclosure:
the interface 2303 is configured to perform step 1602 in FIG. 16; step 1702 in FIG. 17; step 1902 in FIG. 19; step 2002 in FIG. 20; and the like.

In some examples, the chip 2300 further includes a memory 2303, and the memory 2303 is configured to store needed computer program and data.

Those skilled in the art may also know that various illustrative logical blocks and steps listed in the embodiments of the present disclosure may be implemented by electronic hardware, computer software or combining the both. Whether such functions are implemented by the hardware or the software depends on a specific application and a design demand of a whole system. Those skilled in the art may use various methods for implementing the functions for each specific application, but such implementation is not construed as departing from the protection scope of the embodiment of the present disclosure.

The present disclosure further provides a non-transitory computer readable storage medium, storing instructions, where the instructions, when executed by a computer, implement functions in any method embodiment.

The present disclosure further provides a computer program product, where the computer program product, when executed by a computer, implement functions in any method embodiment.

The embodiment may be implemented entirely or partially through software, hardware, firmware or any combination of them. An implementation by the software may be entirely or partially in a form of a computer program product. The computer program product includes one or more computer programs. When the computer programs are loaded and performed on the computer, all or a part of flows or functions according to the embodiment of the present disclosure are generated. The computer may be a general-purpose computer, a special-purpose computer, a computer network, or other programmable devices. The computer program may be stored in a computer-readable storage medium, or transmitted from one computer-readable storage medium to another computer-readable storage medium, for example, the computer program may be transmitted from one website, computer, server or data center to another website, computer, server or data center in a wired mode (for example, a coaxial cable, an optical fiber, a digital subscriber line (DSL)) or wireless mode (for example, infrared, wireless, microwave or the like). The computer-readable storage medium may be any available medium that the computer can access, or a server, a data center and another data storage device including one or more available media integrated. The available medium may be a magnetic medium (for example, a floppy disk, a hard disk and a magnetic tape), an optical medium (for example, a high-density digital video disc (DVD)), or a semiconductor medium (for example, a solid state disk (SSD)), or the like.

Those ordinarily skilled in the art may understand that various ordinal numerals such as first and second involved in the present disclosure are distinguished for convenient description but are not used for limiting the scope of the embodiment of the present disclosure and also represent a sequential order.

At least one in the present disclosure may also be described as one or a plurality, and a plurality may be two, three, four or more, which is not limited in the present disclosure. In the embodiment of the present disclosure, as for a technical feature, technical features on this technical feature are distinguished through “first,” “second,” “third,” “A,” “B,” “C,” “D” and the like, and there is no sequential order or magnitude sequence between the technical features described by “first,” “second,” “third,” “A,” “B,” “C” and “D”.

A corresponding relationship shown in each table in the present disclosure may be configured or pre-defined. Values of information in each table are merely example and may be set as other values, which is not limited in the present disclosure. During configuring the corresponding relationships between the information and the various parameters, all the corresponding relationships shown in each table are not necessarily configured. For example, in the tables in the present disclosure, the corresponding relationships shown in some rows may also be not configured. For another example, a proper variation may be made based on the above tables, for example, splitting, merging and the like. Names of parameters shown in titles in each table may also use other names comprehensible for the communication device, values or representation forms of the parameters may also be other values or representation forms comprehensible for the communication device. In an implementation of each above table, other data structures may also be used, for example, an array, a queue, a container, a stack, a linear table, a pointer, a chain table, a tree, a graph, a structural body, a class, a heap, a hash table, or the like may be used.

As used herein, the term “processor” may refer to one processor that performs the defined functions or a plurality of processors that collectively perform defined functions, such that the execution of the individual defined functions may be divided amongst such processors.

Additional non-limiting embodiments of the disclosure include:

According to an embodiment of a first aspect of the present disclosure, a method for selecting or reselecting a relay user equipment is provided. The method includes:
triggering selecting or reselecting the relay user equipment in a case where a condition for triggering selecting or reselecting the relay user equipment is satisfied.

According to an embodiment of a second aspect of the present disclosure, a method for selecting or reselecting a relay user equipment is provided. The method includes:
obtaining a first sidelink reference signal receiving power (SL-RSRP) or a first sidelink discovery reference signal receiving power (SD-RSRP) of a link between a first user equipment and a second user equipment; and
transmitting first indication signaling to the first user equipment in a case where the first SL-RSRP or the first SD-RSRP is less than or equal to a first preset threshold, where the first indication signaling indicates that the first SL-RSRP or the first SD-RSRP is less than or equal to the first preset threshold.

According to an embodiment of a third aspect of the present disclosure, a method for selecting or reselecting a relay user equipment is provided. The method includes:
obtaining a third SL-RSRP or a third SD-RSRP of a link between a second user equipment and the relay user equipment; and
transmitting third indication signaling to a first user equipment in a case where the third SL-RSRP or the third SD-RSRP is less than or equal to a third preset threshold, where the third indication signaling indicates that the third SL-RSRP or the third SD-RSRP is less than or equal to the third preset threshold.

According to an embodiment of a fourth aspect of the present disclosure, another communication device is provided, including:
a processing module, configured to trigger selecting or reselecting a relay user equipment in a case where a condition for triggering selecting or reselecting the relay user equipment is satisfied.

According to an embodiment of a fifth aspect of the present disclosure, another communication device is provided, including:
a processing module, configured to obtain a first SL-RSRP or a first SD-RSRP of a link between a first user equipment and a second user equipment; and
a transceiving module, configured to transmit first indication signaling to the first user equipment in a case where the first SL-RSRP or the first SD-RSRP is less than or equal to a first preset threshold, where the first indication signaling indicates that the first SL-RSRP or the first SD-RSRP is less than or equal to the first preset threshold.

According to an embodiment of a sixth aspect of the present disclosure, another communication device is provided, including:
a processing module, configured to obtain a third SL-RSRP or a third SD-RSRP of a link between a second user equipment and a relay user equipment; and
a transceiving module, configured to transmit third indication signaling to a first user equipment in a case where the third SL-RSRP or the third SD-RSRP is less than or equal to a third preset threshold, where the third indication signaling indicates that the third SL-RSRP or the third SD-RSRP is less than or equal to the third preset threshold.

According to an embodiment of a seventh aspect of the present disclosure, a communication device is provided, including a processor, where the processor, when calling a computer program in a memory, performs the method in the first aspect.

According to an embodiment of an eighth aspect of the present disclosure, a communication device is provided, including a processor, where the processor, when calling a computer program in a memory, performs the method in the second aspect.

According to an embodiment of a ninth aspect of the present disclosure, a communication device is provided, including a processor, where the processor, when calling a computer program in a memory, performs the method in the third aspect.

According to an embodiment of a tenth aspect of the present disclosure, a communication device is provided, including a processor and a memory, where the memory stores a computer program; and the processor, when executing the computer program stored in the memory, causes the communication device to perform the method in the first aspect.

According to an embodiment of an eleventh aspect of the present disclosure, a communication device is provided, including a processor and a memory, where the memory stores a computer program; and the processor, when executing the computer program stored in the memory, causes the communication device to perform the method in the second aspect.

According to an embodiment of a twelfth aspect of the present disclosure, a communication device is provided, including a processor and a memory, where the memory stores a computer program; and the processor, when executing the computer program stored in the memory, causes the communication device to perform the method in the third aspect.

According to an embodiment of a thirteenth aspect of the present disclosure, another communication device is provided, including a processor and an interface circuit, where the interface circuit is configured to receive a code instruction and transmit the code instruction to the processor, and the processor is configured to run the code instruction to cause the communication device to perform the method in the first aspect.

According to an embodiment of a fourteenth aspect of the present disclosure, another communication device is provided, including a processor and an interface circuit, where the interface circuit is configured to receive a code instruction and transmit the code instruction to the processor, and the processor is configured to run the code instruction to cause the communication device to perform the method in the second aspect.

According to an embodiment of a fifteenth aspect of the present disclosure, another communication device is provided, including a processor and an interface circuit, where the interface circuit is configured to receive a code instruction and transmit the code instruction to the processor, and the processor is configured to run the code instruction to cause the communication device to perform the method in the third aspect.

According to an embodiment of a sixteenth aspect of the present disclosure, a computer-readable storage medium is provided, configured to store instructions used for the communication device, where the instructions, when executed, cause the communication device to perform the method in the first aspect.

According to an embodiment of a seventeenth aspect of the present disclosure, a computer-readable storage medium is provided, configured to store instructions used for the communication device, where the instructions, when executed, cause the communication device to perform the method in the second aspect.

According to an embodiment of an eighteenth aspect of the present disclosure, a computer-readable storage medium is provided, configured to store instructions used for the communication device, where the instructions, when executed, cause the communication device to perform the method in the third aspect.

According to an embodiment of a nineteenth aspect of the present disclosure, a computer program product including a computer program is further provided, where the computer program, when running on a computer, causes the computer to perform the method in the first aspect.

According to an embodiment of a twentieth aspect of the present disclosure, a computer program product including a computer program is further provided, where the computer program, when running on a computer, causes the computer to perform the method in the second aspect.

According to an embodiment of a twenty-first aspect of the present disclosure, a computer program product including a computer program is further provided, where the computer program, when running on a computer, causes the computer to perform the method in the third aspect.

According to an embodiment of a twenty-second aspect of the present disclosure, a chip system is provided, including at least one processor and an interface, configured to support a communication device to implement functions involved in the first aspect, for example, determining or processing at least one of data or information involved in the method. In a design, the chip system further includes a memory, where the memory is configured to store a computer program and data needed by the communication device. The chip system may be composed of chips, or may also include a chip and other discrete devices.

According to an embodiment of a twenty-third aspect of the present disclosure, a chip system is provided, including at least one processor and an interface, configured to support a communication device to implement functions involved in the second aspect, for example, determining or processing at least one of data or information involved in the method. In a design, the chip system further includes a memory, where the memory is configured to store a computer program and data needed by the communication device. The chip system may be composed of chips, or may also include a chip and other discrete devices.

According to an embodiment of a twenty-fourth aspect of the present disclosure, a chip system is provided, including at least one processor and an interface, configured to support a communication device to implement functions involved in the third aspect, for example, determining or processing at least one of data or information involved in the method. In a design, the chip system further includes a memory, where the memory is configured to store a computer program and data needed by the communication device. The chip system may be composed of chips, or may also include a chip and other discrete devices.

According to an embodiment of a twenty-fifth aspect of the present disclosure, a computer program is further provided, where the computer program, when running on a computer, causes the computer to perform the method in the first aspect.

According to an embodiment of a twenty-sixth aspect of the present disclosure, a computer program is further provided, where the computer program, when running on a computer, causes the computer to perform the method in the second aspect.

According to an embodiment of a twenty-seventh aspect of the present disclosure, a computer program is further provided, where the computer program, when running on a computer, causes the computer to perform the method in the third aspect.

1. A method for selecting or reselecting a relay user equipment (UE), performed by a first UE, the method comprising:
triggering selecting or reselecting the relay UE in a case where a condition for triggering selecting or reselecting the relay UE is satisfied.

2. The method according to claim 1, wherein triggering selecting or reselecting the relay UE in a case where the condition for triggering selecting or reselecting the relay UE is satisfied comprises:
obtaining a first sidelink reference signal receiving power (SL-RSRP) or a first sidelink discovery reference signal receiving power (SD-RSRP) of a link between the first UE and a second UE; and
triggering selecting the relay UE in a case where the first SL-RSRP or the first SD-RSRP is less than or equal to a first preset threshold.

3. The method according to claim 2, wherein obtaining the first SL-RSRP or the first SD-RSRP of the link between the first UE and the second UE comprises:
obtaining the first SL-RSRP in a case where data transmission exists between the first UE and the second UE; and
obtaining the first SL-RSRP or the first SD-RSRP in a case where no data transmission exists between the first UE and the second UE.

4. The method according to claim 1, wherein triggering selecting or reselecting the relay UE in a case where the condition for triggering selecting or reselecting the relay UE is satisfied comprises:
triggering selecting the relay UE in response to detecting occurrence of a sidelink radio link failure (SL-RLF) for a link between the first UE and a second UE.

5. The method according to claim 1, wherein triggering selecting or reselecting the relay UE in a case where the condition for triggering selecting or reselecting the relay UE is satisfied comprises:
obtaining a second sidelink reference signal receiving power (SL-RSRP) or a second sidelink discovery reference signal receiving power (SD-RSRP) of a link between the first UE and a current relay UE; and
triggering reselecting the relay UE in a case where the second SL-RSRP or the second SD-RSRP is less than or equal to a second preset threshold.

6. The method according to claim 1, wherein triggering selecting or reselecting the relay UE in a case where the condition for triggering selecting or reselecting the relay UE is satisfied comprises:
triggering reselecting the relay UE in response to detecting occurrence of a sidelink radio link failure (SL-RLF) for a link between the first UE and a current relay UE.

7. The method according to claim 1, wherein triggering selecting or reselecting the relay UE in a case where the condition for triggering selecting or reselecting the relay UE is satisfied comprises one of:
obtaining first indication signaling transmitted by a second UE, wherein the first indication signaling indicates that a first sidelink reference signal receiving power (SL-RSRP) or a first sidelink discovery reference signal receiving power (SD-RSRP) of a link between the first UE and the second UE is less than or equal to a first preset threshold; and
triggering selecting the relay UE according to the first indication signaling; or
obtaining second indication signaling transmitted by a second UE forwarded by a current relay UE, wherein the second indication signaling indicates that a third SL-RSRP or a third SD-RSRP of a link between the second UE and a current relay UE is less than or equal to a third preset threshold; and
triggering reselecting the relay UE according to the second indication signaling; or
obtaining third indication signaling transmitted by a current relay UE, wherein the third indication signaling indicates that a third SL-RSRP or a third SD-RSRP of a link between a second UE and the current relay UE is less than or equal to a third preset threshold; and
triggering reselecting the relay UE according to the third indication signaling; or
obtaining fourth indication signaling transmitted by a current relay UE, wherein the fourth indication signaling indicates occurrence of a sidelink radio link failure (SL-RLF) for a link between a second UE and the current relay UE; and
triggering reselecting the relay UE according to the fourth indication signaling.

8.-10. (canceled)

11. The method according to claim 1, wherein triggering selecting or reselecting the relay UE in a case where the condition for triggering selecting or reselecting the relay UE is satisfied comprises:
obtaining a notification message transmitted by a second UE forwarded by a current relay UE; and
determining, according to the notification message, that the second UE is selecting or reselecting the relay UE and that the first UE stops selecting or reselecting the relay UE;
wherein the notification message is any one of: a discovery request message; a discovery response message; a direct communication request (DCR) message;
or a direct communication accept (DCA) message.

12. (canceled)

13. The method according to claims 1, wherein the first UE is a UE for transmitting a direct communication request (DCR) message, the second UE is a UE for transmitting a direct communication accept (DCA) message; or the second UE is the UE for transmitting the DCR message, and the first UE is the UE for transmitting the DCA message.

14. A method for selecting or reselecting a relay user equipment (UE), performed by a second UE, the method comprising:
obtaining a first sidelink reference signal receiving power (SL-RSRP) or a first sidelink discovery reference signal receiving power (SD-RSRP) of a link between a first UE and the second UE; and
transmitting first indication signaling to the first UE in a case where the first SL-RSRP RSRP or the first SD-RSRP is less than or equal to a first preset threshold, wherein the first indication signaling indicates that the first SL-RSRP or the first SD-RSRP is less than or equal to the first preset threshold.

15. The method according to claim 14, further comprising:
obtaining a third SL-RSRP or a third SD-RSRP of a link between the second UE and a current relay UE; and
transmitting second indication signaling to the first UE through the current relay UE in a case where the third SL-RSRP or the third SD-RSRP is less than or equal to a third preset threshold, wherein the second indication signaling indicates that the third SL-RSRP or the third SD-RSRP is less than or equal to the third preset threshold.

16. The method according to claim 14, further comprising:
not triggering reselecting the relay UE in a case where occurrence of a sidelink radio link failure (SL-RLF) for a link between the second UE and a current relay UE is detected.

17. The method according to claim 14, further comprising:
transmitting a notification message to the first UE through a current relay UE, wherein the notification message is configured to determine that the second UE is selecting or reselecting the relay UE;
wherein the notification message is any one of: a discovery request message; a discovery response message; a direct communication request (DCR) message;
or a direct communication accept (DCA) message.

18. (canceled)

19. The method according to claim 14, wherein the first UE is a UE for transmitting a direct communication request (DCR) message, the second UE is a UE for transmitting a direct communication accept (DCA) message; or the second UE is the UE for transmitting the DCR message, and the first UE is the UE for transmitting the DCA message.

20. A method for selecting or reselecting a relay user equipment (UE), performed by the relay UE, the method comprising:
obtaining a third sidelink reference signal receiving power (SL-RSRP) or a third sidelink discovery reference signal receiving power (SD-RSRP) of a link between a second UE and the relay UE; and
transmitting third indication signaling to a first UE in a case where the third SL-RSRP or the third SD-RSRP is less than or equal to a third preset threshold, wherein the third indication signaling indicates that the third SL-RSRP or the third SD-RSRP is less than or equal to the third preset threshold.

21. The method according to claim 20, further comprising one of:
transmitting fourth indication signaling to the first UE in a case where occurrence of a sidelink radio link failure (SL-RLF) for a link between the second UE and the relay UE is detected, wherein the fourth indication signaling indicates the occurrence of the SL-RLF for the link between the second UE and the relay UE; or
not transmitting, to the second UE, indication signaling for indicating occurrence of a SL-RLF for a link between the first UE and the relay UE, in a case where the occurrence of the SL-RLF for the link between the first UE and the relay UE is detected.

22. (canceled)

23. The method according to claim 20, further comprising:
obtaining a notification message transmitted by the second UE, wherein the notification message is configured to determine that the second UE is selecting or reselecting the relay UE; and
forwarding the notification message to the first UE;
wherein the notification message is any one of: a discovery request message; a discovery response message; a direct communication request (DCR) message;
or a direct communication accept (DCA) message.

24. (canceled)

25. The method according to claim 20, further comprising:
obtaining second indication signaling transmitted by the second UE, wherein the second indication signaling indicates that the third SL-RSRP or the third SD-RSRP is less than or equal to the third preset threshold; and
forwarding the second indication signaling to the first UE.

26. The method according to claim 20, wherein the first UE is a UE for transmitting a direct communication request (DCR) message, the second UE is a UE for transmitting a direct communication accept (DCA) message; or the second UE is the UE for transmitting the DCR message, and the first UE is the UE for transmitting the DCA message.

27.-29. (canceled)

30. A communication device, comprising one or more processors and a memory, wherein the memory stores a computer program, the one or more processors collectively executes the computer program stored in the memory to cause the communication device to perform the method according to claim 1.

31. (canceled)
